(19) United States
(12) Patent Application Publication
(10) Pub. No.: US 2026/0230266 A1
(43) Pub. Date: Aug. 6, 2026

(54) TECHNIQUES FOR SOUNDING REFERENCE SIGNAL RESOURCE SET REPETITION

(71) Applicant: QUALCOMM Incorporated, San Diego, CA (US)

(72) Inventors: Qiaoyu LI, Beijing (CN); Tao LUO, San Diego, CA (US); Mahmoud TAHERZADEH BOROUJENI, San Diego, CA (US)

(21) Appl. No.: 19/152,374

(22) PCT Filed: Mar. 30, 2023
(86) PCT No.: PCT/CN2023/084986

§ 371 Date: Jul. 30, 2025

(51) Int. Cl. H04L 5/00; H04W 16/28; H04W 72/0446; H04W 72/20

(52) U.S. Cl. CPC H04L 5/0051; H04W 16/28; H04W 72/0446; H04W 72/20

(57) ABSTRACT

Methods, systems, and devices for wireless communications are described. A user equipment (UE) may receive control signaling indicating a first time domain periodicity value for transmitting a first sounding reference signal (SRS) set burst via a set of SRS resource set occasions. The UE may transmit a first SRS resource set in a first SRS resource set occasion of the set of SRS resource set occasions and a second SRS resource set in a second SRS resource set occasion of the set of SRS resource set occasions in accordance with the first time domain periodicity value. The UE may also transmit, in accordance with the first time domain periodicity value, a first SRS via the first SRS resource set and a second SRS via the second SRS resource set using a common transmit spatial filter based on the control signaling.

### CROSS REFERENCE

The present Application is a 371 national phase filing of International PCT Application No. PCT/CN2023/084986 by LI et al., entitled “TECHNIQUES FOR SOUNDING REFERENCE SIGNAL RESOURCE SET REPETITION,” filed Mar. 30, 2023, which is assigned to the assignee hereof, and which is expressly incorporated by reference in its entirety herein.

### FIELD OF TECHNOLOGY

The following relates to wireless communications, including techniques for sounding reference signal (SRS) resource set repetition.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for sounding reference signal (SRS) resource set repetition. For example, the described techniques provide for a user equipment (UE) to receive control signaling indicating a first time domain periodicity value for transmitting a first SRS set burst via a set of SRS resource set occasions. The UE 115 may transmit a first SRS resource set in a first SRS resource set occasion of the set of SRS resource set occasions and a second SRS resource set in a second SRS resource set occasion of the set of SRS resource set occasions in accordance with the first time domain periodicity value. The UE may also transmit, in accordance with the first time domain periodicity value, a first SRS via the first SRS resource set and a second SRS via the second SRS resource set using a common transmit spatial filter based on the control signaling.

A method for wireless communication at a UE is described. The method may include receiving control signaling indicating a first time domain periodicity value for transmitting a first SRS resource set burst via a set of multiple SRS resource set occasions, where a first SRS resource set in a first SRS resource set occasion of the set of multiple SRS resource set occasions and a second SRS resource set in a second SRS resource set occasion of the set of multiple SRS resource set occasions are to be transmitted in accordance with the first time domain periodicity value and transmitting, in accordance with the first time domain periodicity value, a first SRS via the first SRS resource set and a second SRS via the second SRS resource set using a common transmit spatial filter based on the control signaling.

An apparatus for wireless communication at a UE is described. The apparatus may include a processor, memory coupled with the processor, and instructions stored in the memory. The instructions may be executable by the processor to cause the apparatus to receive control signaling indicating a first time domain periodicity value for transmitting a first SRS resource set burst via a set of multiple SRS resource set occasions, where a first SRS resource set in a first SRS resource set occasion of the set of multiple SRS resource set occasions and a second SRS resource set in a second SRS resource set occasion of the set of multiple SRS resource set occasions are to be transmitted in accordance with the first time domain periodicity value and transmit, in accordance with the first time domain periodicity value, a first SRS via the first SRS resource set and a second SRS via the second SRS resource set using a common transmit spatial filter based on the control signaling.

Another apparatus for wireless communication at a UE is described. The apparatus may include means for receiving control signaling indicating a first time domain periodicity value for transmitting a first SRS resource set burst via a set of multiple SRS resource set occasions, where a first SRS resource set in a first SRS resource set occasion of the set of multiple SRS resource set occasions and a second SRS resource set in a second SRS resource set occasion of the set of multiple SRS resource set occasions are to be transmitted in accordance with the first time domain periodicity value and means for transmitting, in accordance with the first time domain periodicity value, a first SRS via the first SRS resource set and a second SRS via the second SRS resource set using a common transmit spatial filter based on the control signaling.

A non-transitory computer-readable medium storing code for wireless communication at a UE is described. The code may include instructions executable by a processor to receive control signaling indicating a first time domain periodicity value for transmitting a first SRS resource set burst via a set of multiple SRS resource set occasions, where a first SRS resource set in a first SRS resource set occasion of the set of multiple SRS resource set occasions and a second SRS resource set in a second SRS resource set occasion of the set of multiple SRS resource set occasions are to be transmitted in accordance with the first time domain periodicity value and transmit, in accordance with the first time domain periodicity value, a first SRS via the first SRS resource set and a second SRS via the second SRS resource set using a common transmit spatial filter based on the control signaling.

In some examples of the method, apparatuses, and non-transitory computer-readable medium described herein, receiving the control signaling may include operations, features, means, or instructions for receiving an indication of a second time domain periodicity value for transmitting a set of multiple SRS resource set bursts including the first SRS resource set burst and a second SRS resource set burst, where the first SRS resource set burst and the second SRS resource set burst may be to be transmitted in accordance with the second time domain periodicity value.

Some examples of the method, apparatuses, and non-transitory computer-readable medium described herein may further include operations, features, means, or instructions for transmitting, in accordance with the second time domain periodicity value, a first SRS via the first SRS resource set burst and a first SRS via the second SRS resource set burst using a common transmit spatial filter.

Some examples of the method, apparatuses, and non-transitory computer-readable medium described herein may further include operations, features, means, or instructions for transmitting, in accordance with the second time domain periodicity value, a first SRS via the first SRS resource set burst using a first transmit spatial filter and a first SRS via the second SRS resource set burst using a second transmit spatial filter that may be different than the first transmit spatial filter.

In some examples of the method, apparatuses, and non-transitory computer-readable medium described herein, receiving the control signaling may include operations, features, means, or instructions for receiving a radio resource control message including the control signaling, the radio resource control message indicating a time domain prediction usage of the set of multiple SRS resource set occasions.

In some examples of the method, apparatuses, and non-transitory computer-readable medium described herein, the radio resource control message includes an indication of the common transmit spatial filter applied to a respective SRS in each of a set of multiple SRS resource sets, a common transmit spatial filter applied to a respective SRS in each of a set of multiple SRS resource set bursts, or both.

In some examples of the method, apparatuses, and non-transitory computer-readable medium described herein, the radio resource control message includes a radio resource control flag indicating whether the common transmit spatial filter may be to be applied to a respective SRS in each of a set of multiple SRS resource sets, whether a common transmit spatial filter may be to be applied to a respective SRS in each of a set of multiple SRS resource set bursts, or both.

In some examples of the method, apparatuses, and non-transitory computer-readable medium described herein, receiving the control signaling may include operations, features, means, or instructions for receiving a medium access control channel element message activating a set of multiple SRS resource sets including the first SRS resource set and the second SRS resource set, where the medium access control channel element message indicates whether the common transmit spatial filter may be to be applied to a respective SRS in each of the set of multiple SRS resource sets, whether a common transmit spatial filter may be to be applied to a respective SRS in each of a set of multiple SRS resource set bursts, or both.

In some examples of the method, apparatuses, and non-transitory computer-readable medium described herein, receiving the control signaling may include operations, features, means, or instructions for receiving a first medium access control channel element message activating a set of multiple SRS resource sets including the first SRS resource set and the second SRS resource set and receiving a second medium access control channel element message indicating one or more SRS resource set identifiers, where the second medium access control channel element message indicates whether the common transmit spatial filter may be to be applied to a respective SRS in each of the set of multiple SRS resource sets, whether a common transmit spatial filter may be to be applied to a respective SRS in each of a set of multiple SRS resource set bursts, or both.

In some examples of the method, apparatuses, and non-transitory computer-readable medium described herein, receiving the control signaling may include operations, features, means, or instructions for receiving a downlink control information message including the control signaling, the downlink control information message indicating whether the common transmit spatial filter may be to be applied to a respective SRS in each of a set of multiple SRS resource sets, whether a common transmit spatial filter may be to be applied to a respective SRS in each of a set of multiple SRS resource set bursts, or both.

In some examples of the method, apparatuses, and non-transitory computer-readable medium described herein, the downlink control information message includes a SRS resource set identifier and indicates whether the common transmit spatial filter may be to be applied to a respective SRS in each of the set of multiple SRS resource sets, whether a common transmit spatial filter may be to be applied to a respective SRS in each of the set of multiple SRS resource set bursts, or both, based on the SRS resource set identifier.

In some examples of the method, apparatuses, and non-transitory computer-readable medium described herein, receiving the control signaling may include operations, features, means, or instructions for receiving a first control signal indicating a set of multiple candidate options for the first time domain periodicity value and a second time domain periodicity value, where the set of multiple candidate options may be associated with a set of multiple option identifiers and receiving a second control signal activating a set of multiple SRS resource sets including the first SRS resource set and the second SRS resource set, the second control signal including an option identifier from set of multiple option identifiers.

A method for wireless communication at a UE is described. The method may include receiving control signaling indicating a set of multiple SRS resource sets including at least a first SRS resource set and a second SRS resource set, where each SRS resource set includes a same quantity of SRSs and transmitting a first SRS via the first SRS resource set and a second SRS via the second SRS resource set using a common transmit spatial filter based on the control signaling.

An apparatus for wireless communication at a UE is described. The apparatus may include a processor, memory coupled with the processor, and instructions stored in the memory. The instructions may be executable by the processor to cause the apparatus to receive control signaling indicating a set of multiple SRS resource sets including at least a first SRS resource set and a second SRS resource set, where each SRS resource set includes a same quantity of SRSs and transmit a first SRS via the first SRS resource set and a second SRS via the second SRS resource set using a common transmit spatial filter based on the control signaling.

Another apparatus for wireless communication at a UE is described. The apparatus may include means for receiving control signaling indicating a set of multiple SRS resource sets including at least a first SRS resource set and a second SRS resource set, where each SRS resource set includes a same quantity of SRSs and means for transmitting a first SRS via the first SRS resource set and a second SRS via the second SRS resource set using a common transmit spatial filter based on the control signaling.

A non-transitory computer-readable medium storing code for wireless communication at a UE is described. The code may include instructions executable by a processor to receive control signaling indicating a set of multiple SRS resource sets including at least a first SRS resource set and a second SRS resource set, where each SRS resource set includes a same quantity of SRSs and transmit a first SRS via the first SRS resource set and a second SRS via the second SRS resource set using a common transmit spatial filter based on the control signaling.

In some examples of the method, apparatuses, and non-transitory computer-readable medium described herein, the control signaling indicates whether the common transmit spatial filter may be to be applied to a respective SRS in each of the set of multiple SRS resource sets.

In some examples of the method, apparatuses, and non-transitory computer-readable medium described herein, receiving the control signaling may include operations, features, means, or instructions for receiving a radio resource control message including the control signaling, the radio resource control message indicating a time domain prediction usage of a set of multiple SRS resource set occasions.

In some examples of the method, apparatuses, and non-transitory computer-readable medium described herein, the usage of the radio resource control message may be a sub usage of a beam management usage.

In some examples of the method, apparatuses, and non-transitory computer-readable medium described herein, each SRS resource set with the usage of time domain predication may be associated with each other in accordance with a single virtual SRS resource set, and where a quantity of SRSs within the single virtual SRS resource set may be based on a quantity of SRSs within each associated SRS resource set.

Some examples of the method, apparatuses, and non-transitory computer-readable medium described herein may further include operations, features, means, or instructions for transmitting a capability message indicating a maximum number of SRS resource sets in the set of multiple SRS resource sets, a maximum number of SRSs for each SRS resource set of the set of multiple SRS resource sets, or both.

In some examples of the method, apparatuses, and non-transitory computer-readable medium described herein, the first SRS in the second SRS set may be associated with the first SRS in the first SRS set.

In some examples of the method, apparatuses, and non-transitory computer-readable medium described herein, each SRS resource set of the set of multiple SRS resource sets includes a SRS resource set identifier indicating that the SRS resource set may be associated with the first SRS resource set.

In some examples of the method, apparatuses, and non-transitory computer-readable medium described herein, each SRS resource set of the set of multiple SRS resource sets includes a group identifier indicating that the SRS resource set may be associated with a group of SRS resource sets.

A method for wireless communication at a network entity is described. The method may include transmitting a control signaling indicating a first time domain periodicity value for transmitting a first SRS resource set burst via a set of multiple SRS resource set occasions, where a first SRS resource set in a first SRS resource set occasion of the set of multiple SRS resource set occasions and a second SRS resource set in a second SRS resource set occasion of the set of multiple SRS resource set occasions are to be received in accordance with the first time domain periodicity value and receiving, in accordance with the first time domain periodicity value, a first SRS via the first SRS resource set and a first SRS via the second SRS resource set using a common transmit spatial filter based on the control signaling.

An apparatus for wireless communication at a network entity is described. The apparatus may include a processor, memory coupled with the processor, and instructions stored in the memory. The instructions may be executable by the processor to cause the apparatus to transmit a control signaling indicating a first time domain periodicity value for transmitting a first SRS resource set burst via a set of multiple SRS resource set occasions, where a first SRS resource set in a first SRS resource set occasion of the set of multiple SRS resource set occasions and a second SRS resource set in a second SRS resource set occasion of the set of multiple SRS resource set occasions are to be received in accordance with the first time domain periodicity value and receive, in accordance with the first time domain periodicity value, a first SRS via the first SRS resource set and a first SRS via the second SRS resource set using a common transmit spatial filter based on the control signaling.

Another apparatus for wireless communication at a network entity is described. The apparatus may include means for transmitting a control signaling indicating a first time domain periodicity value for transmitting a first SRS resource set burst via a set of multiple SRS resource set occasions, where a first SRS resource set in a first SRS resource set occasion of the set of multiple SRS resource set occasions and a second SRS resource set in a second SRS resource set occasion of the set of multiple SRS resource set occasions are to be received in accordance with the first time domain periodicity value and means for receiving, in accordance with the first time domain periodicity value, a first SRS via the first SRS resource set and a first SRS via the second SRS resource set using a common transmit spatial filter based on the control signaling.

A non-transitory computer-readable medium storing code for wireless communication at a network entity is described. The code may include instructions executable by a processor to transmit a control signaling indicating a first time domain periodicity value for transmitting a first SRS resource set burst via a set of multiple SRS resource set occasions, where a first SRS resource set in a first SRS resource set occasion of the set of multiple SRS resource set occasions and a second SRS resource set in a second SRS resource set occasion of the set of multiple SRS resource set occasions are to be received in accordance with the first time domain periodicity value and receive, in accordance with the first time domain periodicity value, a first SRS via the first SRS resource set and a first SRS via the second SRS resource set using a common transmit spatial filter based on the control signaling.

In some examples of the method, apparatuses, and non-transitory computer-readable medium described herein, transmitting the control signaling may include operations, features, means, or instructions for transmitting an indication of a second time domain periodicity value for transmitting a set of multiple SRS resource set bursts including the first SRS resource set burst and a second SRS resource set burst, where the first SRS resource set burst and the second SRS resource set burst may be to be transmitted in accordance with the second time domain periodicity value.

Some examples of the method, apparatuses, and non-transitory computer-readable medium described herein may further include operations, features, means, or instructions for receiving, in accordance with the second time domain periodicity value, a first SRS via the first SRS resource set burst and a first SRS via the second SRS resource set burst using a common transmit spatial filter.

Some examples of the method, apparatuses, and non-transitory computer-readable medium described herein may further include operations, features, means, or instructions for receiving, in accordance with the second time domain periodicity value, a first SRS via the first SRS resource set burst using a first transmit spatial filter and a first SRS via the second SRS resource set burst using a second transmit spatial filter that may be different than the first transmit spatial filter.

In some examples of the method, apparatuses, and non-transitory computer-readable medium described herein, transmitting the control signaling may include operations, features, means, or instructions for transmitting a radio resource control message including the control signaling, the radio resource control message indicating a time domain prediction usage of the set of multiple SRS resource set occasions.

A method for wireless communications at a network entity is described. The method may include transmitting control signaling indicating a set of multiple SRS resource sets including at least a first SRS resource set and a second SRS resource set, where each SRS resource set includes a same quantity of SRSs and receiving a first SRS via the first SRS resource set and a second SRS via the second SRS resource set using a common transmit spatial filter based on the control signaling.

An apparatus for wireless communications at a network entity is described. The apparatus may include a processor, memory coupled with the processor, and instructions stored in the memory. The instructions may be executable by the processor to cause the apparatus to transmit control signaling indicating a set of multiple SRS resource sets including at least a first SRS resource set and a second SRS resource set, where each SRS resource set includes a same quantity of SRSs and receive a first SRS via the first SRS resource set and a second SRS via the second SRS resource set using a common transmit spatial filter based on the control signaling.

Another apparatus for wireless communications at a network entity is described. The apparatus may include means for transmitting control signaling indicating a set of multiple SRS resource sets including at least a first SRS resource set and a second SRS resource set, where each SRS resource set includes a same quantity of SRSs and means for receiving a first SRS via the first SRS resource set and a second SRS via the second SRS resource set using a common transmit spatial filter based on the control signaling.

A non-transitory computer-readable medium storing code for wireless communications at a network entity is described. The code may include instructions executable by a processor to transmit control signaling indicating a set of multiple SRS resource sets including at least a first SRS resource set and a second SRS resource set, where each SRS resource set includes a same quantity of SRSs and receive a first SRS via the first SRS resource set and a second SRS via the second SRS resource set using a common transmit spatial filter based on the control signaling.

In some examples of the method, apparatuses, and non-transitory computer-readable medium described herein, the control signaling indicates whether the common transmit spatial filter may be to be applied to a respective SRS in each of the set of multiple SRS resource sets.

Some examples of the method, apparatuses, and non-transitory computer-readable medium described herein may further include operations, features, means, or instructions for receiving a capability message indicating a maximum number of SRS resource sets in the set of multiple SRS resource sets, a maximum number of SRSs for each SRS resource set of the set of multiple SRS resource sets, or both.

In some examples of the method, apparatuses, and non-transitory computer-readable medium described herein, the first SRS in the second SRS set may be associated with the first SRS in the first SRS set.

### BRIEF DESCRIPTION OF THE DRAWINGS

FIG. 1 shows an example of a wireless communications system that supports techniques for sounding reference signal (SRS) resource set repetition in accordance with one or more aspects of the present disclosure.

FIG. 2 shows an example of a wireless communications system that supports techniques for SRS resource set repetition in accordance with one or more aspects of the present disclosure.

FIGS. 3 through 5 show examples of resource allocations that supports techniques for SRS resource set repetition in accordance with one or more aspects of the present disclosure.

FIGS. 6 and 7 show examples of a process flow that supports techniques for SRS resource set repetition in accordance with one or more aspects of the present disclosure.

FIGS. 8 and 9 show block diagrams of devices that support techniques for SRS resource set repetition in accordance with one or more aspects of the present disclosure.

FIG. 10 shows a block diagram of a communications manager that supports techniques for SRS resource set repetition in accordance with one or more aspects of the present disclosure.

FIG. 11 shows a diagram of a system including a device that supports techniques for SRS resource set repetition in accordance with one or more aspects of the present disclosure.

FIGS. 12 and 13 show block diagrams of devices that support techniques for SRS resource set repetition in accordance with one or more aspects of the present disclosure.

FIG. 14 shows a block diagram of a communications manager that supports techniques for SRS resource set repetition in accordance with one or more aspects of the present disclosure.

FIG. 15 shows a diagram of a system including a device that supports techniques for SRS resource set repetition in accordance with one or more aspects of the present disclosure.

FIGS. 16 through 22 show flowcharts illustrating methods that support techniques for SRS resource set repetition in accordance with one or more aspects of the present disclosure.

### DETAILED DESCRIPTION

In some wireless communications systems a network entity may receive sounding reference signals (SRSs) transmitted from a user equipment (UE) during a set of consecutive SRS occasions. SRSs transmitted by the UE in the uplink direction may be used by the network entity to estimate an uplink channel. In some examples, the network entity may perform uplink beam prediction using the SRSs. For example, the network entity may attempt to predict one or more uplink transmission configuration indication (TCI) state(s), SRS resource indicator(s) (SRIs), or transmit precoder matrix indicator(s) (TMPIs) for the duration between SRSs in an SRS occasion and SRSs in the next consecutive SRS occasions. To perform such predictions, it may be beneficial for the network entity to observe the consecutive SRS occasions in different slots in which the uplink transmission spatial filters are the same. However, if a UE transmits repetitions of SRSs within a same slot it may be more difficult for the network entity to identify the rotations and movement of the UE and therefore predict future uplink transmission beams. Additionally, for each SRS, the UE may use a spatial filter that may be the same as a spatial filter associated with a downlink reference signal triggering the SRS transmission. However, such SRS precoders may still vary depending on time domain interactions between the downlink reference signal and the transmissions of the SRS resources. As such, transmission of the SRSs may be improved and help with the prediction of future uplink transmission beams.

The techniques of the present disclosure may introduce more flexible SRS occasion configuration patterns to enhance the prediction of future uplink transmission beams. For example, the UE may receive control signaling indicating a periodicity and offset for an SRS resource set. The periodicity and the offset may include a first periodicity (P1) and a second periodicity (P2), where P1<P2. In this example, the UE may transmit repetitions of an SRS during a set of consecutive SRS occasions in an SRS resource set burst. The UE may transmit the SRSs during such occasions according to P1 and may transmit the SRS resource set bursts according to P2. Additionally, within an SRS resource set burst, the transmit spatial filter may remain the same across each of the SRS occasions within the SRS resource set burst.

In some examples, for periodic or semi-periodic SRS resource sets, a radio resource control (RRC) may configure usage information for an SRS resource set. For example, the RRC message may indicate a time domain prediction usage for the SRS resource set. Based on the usage information, the UE may choose to use a common transmit spatial filter for each respective SRS in the SRS resource set. Additionally, or alternatively, the usage may indicate that a group of multiple SRS resources sets including an identical quantity of SRSs may be associated with each other. The group of SRS resource sets may include SRS resource set identifiers (IDs) or group IDs to indicate the association between the SRS resources. In some examples, for aperiodic resource sets, the UE may receive control signaling that triggers the transmission for an SRS resource set. The control signaling may indicate whether the uplink transmission spatial filter for the SRS resource set is the same as a previous set. As such, the UE may use the techniques described herein for such flexible configurations to improve predictions of future uplink transmission beams.

Aspects of the disclosure are initially described in the context of wireless communications systems. Additional aspects of the disclosure are described herein with reference to a wireless communications system, resource allocations, and process flows. Aspects of the disclosure are further illustrated by and described with reference to apparatus diagrams, system diagrams, and flowcharts that relate to techniques for SRS resource set repetition.

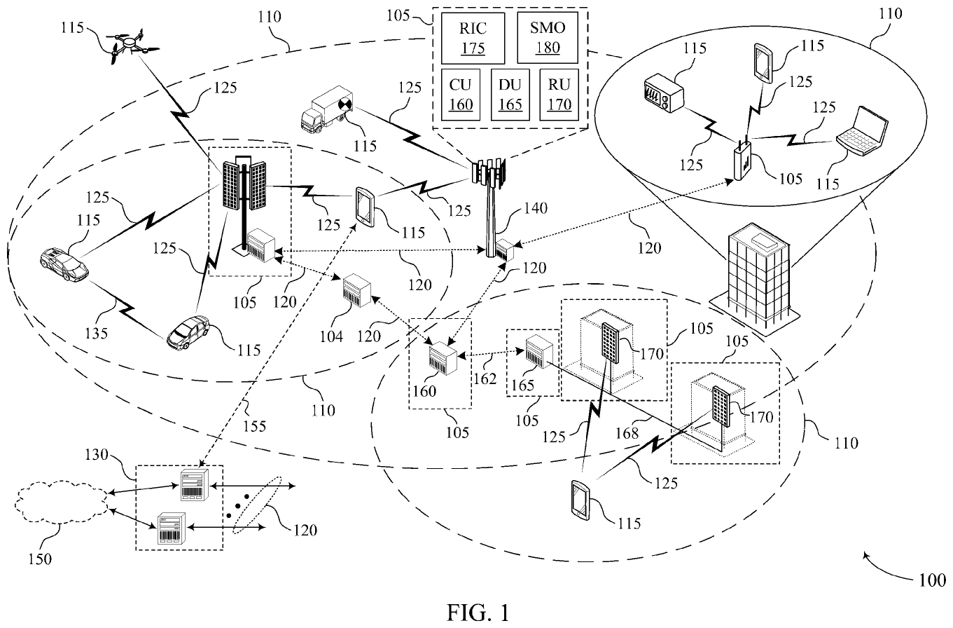

FIG. 1 shows an example of a wireless communications system 100 that supports techniques for SRS resource set repetition in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for SRS resource set repetition as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Nr may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of the wireless communications system 100, the UE 115 and the network entity 105 may use artificial intelligence (AI) and machine learning (ML) procedures and models to enhance beam management. For example, such AI and ML models may be used for beam predictions in the time domain, beam predictions in the spatial domain, or both, to reduce overhead and latency and increase beam selection accuracies. In some cases, the AI and ML techniques may support collaborations between the network entity 105 and the UE 115. As such, the network entity 105 and the UE 115 may perform model training, model deployment, model inference, model monitoring, and model updating for the various AI and ML models used for beam prediction to identify common characteristics or specific characteristics for the beam predictions.

In some examples, wireless devices that support AI and ML based beam management (e.g., the UE 115 and the network entity 105) may support a first beam management case and a second beam management case for characterization and baseline performance evaluations. The first beam management case may include the wireless devices performing spatial-domain downlink beam predictions for a first set of beams based on measurement results of a second set of beams. In some cases, the second set of beams may be a subset of the first set of beams, where the wireless device may select or generate the second set of beams via a fixed pattern, a random pattern, or any other type of technique. In some cases, the first set of beams and the second set of beams may be different (e.g., the first set of beams include narrow beams and the second set of beams include wide beams). In some examples, the first set of beams and the second set of beams may have a same quantity of beams, have different quantities of beams, be quasi co-located (QCL) with each other, or any combination thereof.

The second beam management case may include the wireless devices performing temporal downlink beam predictions for the first set of beams based on historic measurement results of the second set of beams. That is, the AI and ML models may be used to discover patterns in the historical measurement results of the second set of beams to generate the temporal downlink beam predictions for the first set of beams. In either the first beam management case or the second beam management case, the first set of beams and the second set of beams may be in the same frequency or in different frequencies. Additionally, or alternatively, the codebook constructions for the first set of beams and the second set of beams may be configured by the manufacturers of the wireless devices.

For the first beam management case when the UE 115 uses the AI and ML models, level-1 (L1) signaling may be used to report information associated with the AI and ML model interference to the network entity 105. The UE 115 may report information such as beams based on the output of the AI and ML model inference, predicted L1-reference signal receive power (RSRP) corresponding to the output beams, or other types of information. For the second beam management case when the UE 115 uses the AI and ML models, L1-signaling may be used to report information to the network entity 105, such as beams of N future time instances based on the output of the AI/ML model inference, the value of N, the predicted L1-RSRPs corresponding to the beams, information (e.g., explicit information or implicit information) about the timestamps corresponding to the reported beams, or any combination thereof.

For both the first beam management case and the second beam management case, when the UE 115 performs model monitoring, the UE 115 may monitor the performance metrics of the AI and ML models, make decisions about model selection, activation, deactivation, switching, fallback operations, or any combination thereof. When the network entity 105 performs the model monitoring, the network entity 105 may model the performance metrics of the AI and ML models and make decisions for the AI and ML models in a similar fashion as the UE 115. In some cases, both devices (e.g., the UE 115 and the network entity 105) may perform model monitoring and the UE 115 may monitor the performance metrics of the AI and ML models and the network entity 105 may make decisions about model selection, activation, deactivation, switching, fallback operations, or any combination thereof. In some cases, when the network entity 105 monitors the AI and ML models, the network entity 105 may perform beam measurements and generate reports based on the model monitoring.

In addition to performing operations associated with the AI and ML models, the UE 115 may transmit symbol-level repetitions of SRSs to help with beam predictions. For example, the UE 115 may transmit symbol level repetitions for an SRS resource within a same slot. In some cases, the SRS parameters may be semi-statically configurable by a higher layer parameter (e.g., SRS-Resource). The SRS parameters may indicate a quantity of OFDM symbols in the SRS resource, a starting OFDM symbol of the SRS resource within a slot including a repetition factor (R) as defined by a higher layer parameter (e.g., resourceMapping). If R is not configured then R may be equal to the quantity of OFDM symbols in the SRS resource. For a given SRS resource, the UE 115 may be configured with the repetition factor (e.g., R {1, 2, 4} or R∈{1,2,3,4,5,6,7,8,9,10,12,14}) by the higher layer parameter (e.g., resourceMapping in SRS-Resource) when R≤Nₛ, where Nₛ represents a quantity of symbols.

In some examples, when frequency hopping is configured within an SRS resource where R is not configured (e.g., R=Nₛ), each antenna port of the SRS resource in each slot may be mapped to all the symbols (e.g., Nₛ), where all the symbols may use the same set of subcarriers in the same set of physical RBs (PRBs). In some examples, when frequency hopping is configured within an SRS resource and each slot is configured without repetition (e.g., R=1), according to SRS hopping parameters (e.g., B_{SRS}, C_{SRS}, and bₕₒₚ), each of the antenna ports of the SRS resource in each slot may be mapped to different sets of subcarriers in each OFDM symbol, where the same transmission combining value is assumed for the different sets of subcarriers. Additionally, or alternatively, when both frequency hopping within an SRS resource and when each slot may be configured for repetitions (e.g., Nₛ≥4, R≥2), each of the antenna ports of the SRS resource in each slot may be mapped to the same set of subcarriers within each pair of R adjacent OFDM symbols and frequency hopping across the

$$\frac{{N}_{s}}{R}$$

pairs according to the SRS hopping parameters, where Nₛ is divisible by R.

In some examples of the wireless communications system 100, a network entity 105 may receive SRSs transmitted from a UE 115 during a set consecutive of SRS occasions. In some cases, the network entity 105 attempt to predict the uplink TCI states, SRIs, or TPMIs for one or more SRSs. To perform such predictions, it may be beneficial for the network entity 105 to observe the consecutive SRS occasions in different slots in which the transmit spatial filters are the same. However, if the UE 115 transmits repetitions of SRSs within a same slot it may be more difficult for the network entity to identify the rotations and movement of the UE 115 and therefore predict future uplink transmission beams. Additionally, for each SRS transmitted, the UE 115 may use a transmit spatial filter that may be the same as a receiving spatial filter associated with a downlink reference signal triggering the SRS transmission. However, such SRS precoders may still vary depending on time domain interactions between the downlink reference signal and the transmissions of the SRS resources. As such, transmission of the SRSs may be improved and may help with the prediction of future uplink transmission beams.

The techniques of the present disclosure may introduce more flexible SRS occasion configuration patterns to enhance the prediction of future uplink transmission beams. For example, for periodic or semi-periodic SRS resource sets for a single SRS resource set, the UE 115 may receive a configuration, via control signaling, indicating a periodicity and offset for the SRS resource set including a first periodicity (P1) and a second periodicity (P2), where P1<P2. The UE 115 may transmit repetitions of an SRS during a set of consecutive SRS occasions in an SRS resource set burst. The UE 115 may transmit on such occasions according to P1 and the SRS resource set bursts may be transmitted according to P2. Additionally, within an SRS resource set burst, the UE 115 may keep the transmit spatial filter the same across each of the SRS occasions within the SRS resource set burst. In some examples, for periodic or semi-periodic SRS resource sets for multiple SRS resource sets an SRS resource set may be RRC configured with the new usage and a group of multiple SRS resources sets containing an identical quantity of SRSs may be associated with each other. The group of SRS resource sets may include SRS resource set IDs or group IDs to indicate the association between the SRS resources. As such, the UE 115 may use the techniques described herein for such flexible configurations to improve predictions of future uplink transmission beams.

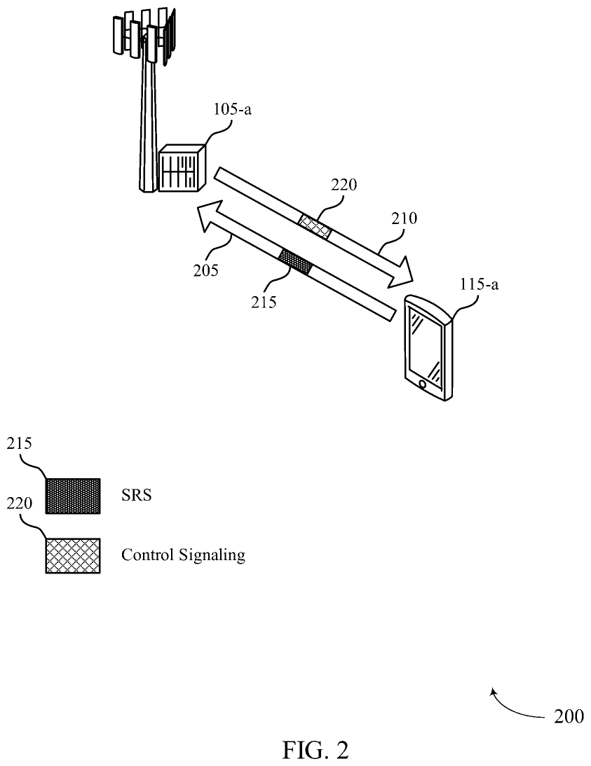

FIG. 2 shows an example of a wireless communications system 200 that supports techniques for SRS resource set repetition in accordance with one or more aspects of the present disclosure. In some examples, the wireless communications system 200 may implement or be implemented by the wireless communications system 100. For example, the wireless communications system 200 may include a UE 115-a and a network entity 105-a, which may be examples of devices described herein with reference to FIG. 1. In some examples, the UE 115-a and the network entity 105-a may communicate via an uplink communication link 205 and via a downlink communication link 210, which may be examples of a communication link 125 described herein with reference to FIG. 1. For example, the uplink communication link 205 and the downlink communication link 210 may be examples of a Uu link, a sidelink, a backhaul link, a D2D link or some other type of communication link 125.

In some examples, the network entity 105-a may receive SRSs 215 from the UE 115-a via the uplink communication link 205 in M consecutive SRS occasions. In some cases, the UE 115-a may transmit repetitions of the SRS 215 to the network entity 105-a in each SRS occasion. As such, the transmissions of the SRS 215 which may be referred to as SRS repetitions. The network entity 105-a may use the received SRSs 215 to attempt to predict uplink TCI states, SRIs, and TPMIs during a duration spanning from after the last SRS 215 transmission in the last SRS occasion up to before the next M consecutive SRS occasions. As such, to support more accurate predictions, the network entity 105-a may observe the M consecutive SRS occasions in different slots and have the uplink transmit spatial filters in the M consecutive SRS occasions be common. If the network entity 105-a receives SRS occasion level SRS repetitions instead of symbol level SRS repetitions, as discussed herein, the network entity 105-a may be able to better identify the current movement and rotation of the UE 115-a during the current or past measurement occasions (e.g., SRS measurement occasions). As such, the network entity 105-a may be able to better predict the upcoming or future movements and rotations of the UE 115-a which may support better uplink transmit beam predictions.

However, the network entity 105-a may configure the UE 115-a to transmit symbol level SRS repetitions. As such, the UE 115-a may transmit the repetitions of the SRSs 215 within the same slot which may make the process of the network entity 105-a identifying and predicting the movement and rotations of the UE 115-a and the network entity 105-a predicting future uplink transmit beams more difficult. In some cases, for each SRS resource, the network entity 105-a may configure, using control signaling 220 via the downlink communication link 210, downlink reference signals with an SRS parameter (e.g., SRS-SpatialRelationInfo) such that the UE 115-a may use a transmit spatial filter that is the same as a receiving spatial filter used to receive the downlink reference signals. The UE 115-a may use the transmit spatial filter to transmit the SRS 215 associated with the downlink reference signal received from the network entity 105-a, however SRS precoders may vary depending on time domain interactions between the downlink reference signal and the SRS. In some examples, the network entity 105-a may identify, based on the QCL of multiple SRS resource sets, the maximum quantity of SRS resource sets and the maximum quantity of SRS resources for the beam management RRC usage (e.g., usage=beamManagement). However, as that may be a UE 115 capability, related configurations for uplink transmit beam prediction purposes may lack the flexibility to improve the uplink transmit beam predictions.

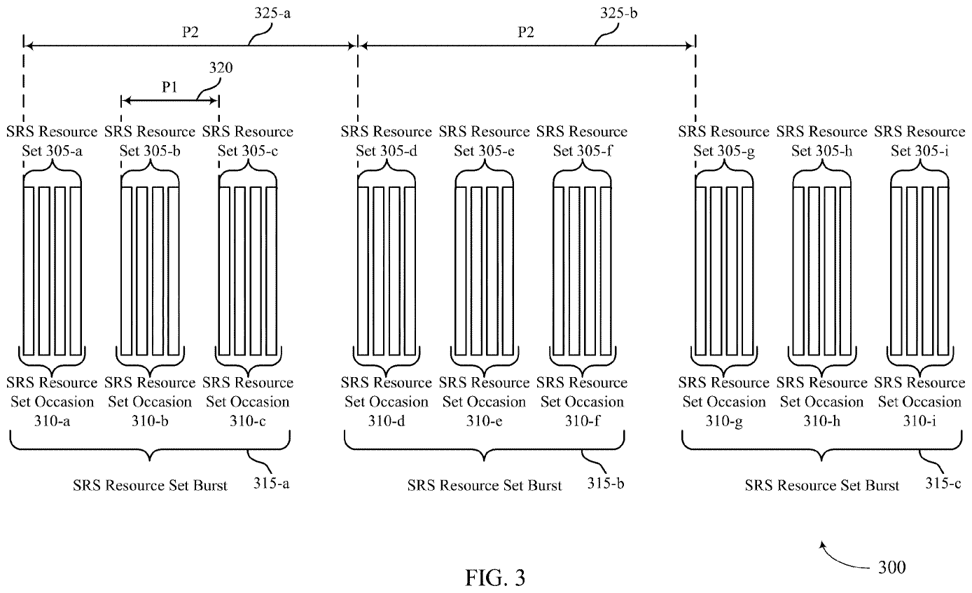

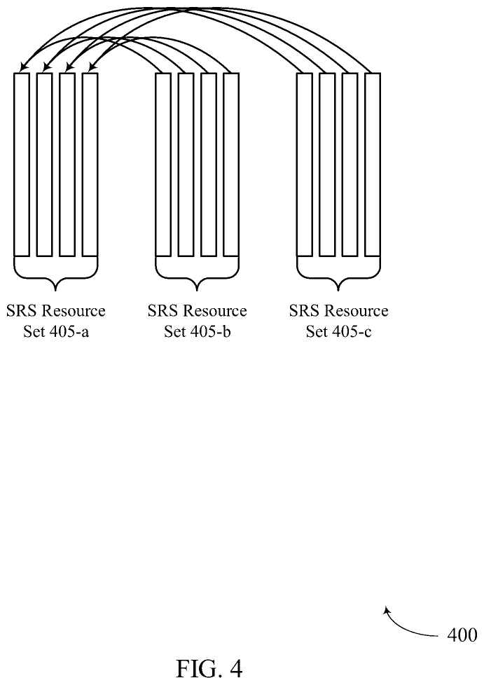

As such, techniques of the present disclosure may support the network entity 105-a transmitting the control signaling 220 indicating more flexible SRS occasion configuration patterns. In such flexible pattens, the network entity 105-a may further indicate SRS occasion level repetitions and additional configurations for the UE 115-a. For example, the network entity 105-a may indicate via the control signaling 220 a common uplink transmit filter to be used between SRSs 215 within an SRS resource set, between SRS resource set occasions, SRS resource set bursts, or any combination thereof. In some cases, the control signaling 220 may also indicate periodicities for transmitting SRS resource sets within SRS resource set occasions of an SRS resource set burst and for transmitting the SRS resource set bursts. Such examples are further described with reference to FIG. 3. Additional descriptions of the techniques of the present disclosure are further provided with reference to FIGS. 4-7.

FIG. 3 shows an example of a resource allocation 300 that supports techniques for SRS resource set repetition in accordance with one or more aspects of the present disclosure. In some examples, the resource allocation 300 may implement or be implemented by the wireless communications system 100 or the wireless communications system 200. For example, the resource allocation 300 illustrates examples of SRS resource sets 305 (e.g., SRS resource set 305-a, SRS resource set 305-b, SRS resource set 305-c, SRS resource set 305-d, SRS resource set 305-e, SRS resource set 305-f, SRS resource set 305-g, SRS resource set 305-h, and SRS resource set 305-i), SRS resource set occasions 310 (e.g., SRS resource set occasion 310-a, SRS resource set occasion 310-b, SRS resource set occasion 310-c, SRS resource set occasion 310-d, SRS resource set occasion 310-e, SRS resource set occasion 310-f, SRS resource set occasion 310-g, SRS resource set occasion 310-h, and SRS resource set occasion 310-i), and SRS resource set bursts 315 (e.g., SRS resource set burst 315-a, SRS resource set burst 315-b, and SRS resource set burst 315-c) to be transmitted from a UE 115 to a network entity 105. In some cases, the network entity 105 may signal the configuration illustrated in FIG. 3 to the UE 115 via a control signaling (e.g., the control signaling 220 with reference to FIG. 2) as illustrated with reference to FIG. 2.

In some examples, the network entity 105 may transmit control signaling indicating periodicities and offsets for the UE 115 to transmit periodic or semi-periodic SRS resource sets 305. For example, the control signaling may indicate a first periodicity 320 (e.g., P₁) and a second periodicity 325 (e.g., P₂). The UE 115 may transmit the SRS resource sets 305 in M consecutive SRS resource set bursts 315 using the first periodicity 320 (e.g., P₁) and transmit the SRS resource set bursts 315 using the second periodicity (e.g., P₂). As such, the first periodicity 320 may be less than the second periodicity 325 (e.g., P₁<P₂). For example, the UE 115 may transmit the SRS resource set 305-b and the SRS resource set 305-c in accordance with the first periodicity 320. That is, the first SRS of the SRS resource set 305-b and the first SRS of the SRS resource set 305-c may be separated by the first periodicity 320. Similarly, the UE 115 may transmit the SRS resource set burst 315-a and the SRS resource set burst 315-b in accordance with the second periodicity 325-a and the UE 115 may transmit the SRS resource set burst 315-b and the SRS resource set burst 315-c in accordance with the second periodicity 325-b.

In such examples, the UE 115 may use a common transmit spatial filter for each SRS in each SRS resource set 305 within each SRS resource set occasion 310 of each SRS resource set burst 315. For example, each SRS resource set 305 may include four SRSs (e.g., a first SRS, a second SRS, a third SRS, and a fourth SRS) and the UE 115 may transmit the first SRS of each SRS resource set 305 within an SRS resource occasion 310 using the same transmit spatial filter (e.g., the common transmit spatial filter). Further, the UE 115 may transmit each SRS within each SRS resource set occasion 310 in the same SRS resource set burst 315 using the same common transmit spatial filter.

For example, within the SRS resource set burst 315-a, the UE 115 may transmit each SRS in the SRS resource set 305-a within the SRS resource set occasion 310-a, each SRS in the SRS resource set 305-b within the SRS resource set occasion 310-b, and each SRS in the SRS resource set 305-c using the same common transmit spatial filter. In some cases, the UE 115 may use the same common transmit spatial filter for transmitting SRS in the SRS resource set burst 315-a, the SRS resource set burst 315-b, and the SRS resource set burst 315-c. In some cases, the UE 115 may use different transmit spatial filters in the different SRS resource set bursts 315. However, while the different SRS resource set bursts 315 may use different transmit spatial filters, the transmit spatial filter used within the respective SRS resource set burst 315 may be common to all the SRSs in each SRS resource set 305 within each SRS resource set occasion of the respective SRS resource set burst 315.

The transmit spatial filter may be a filter applied to a beam used by the UE 115 to transmit a respective SRS. The spatial filter may determine the direction, shape, and power of the beam. In cases where the UE 115 uses the same spatial filter to transmit each SRS, the filter may form the same beam for each SRS transmission. That is, when the UE 115 uses a common transmit spatial filter to transmit the SRSs in an SRS resource set burst 315, the network entity 105 may receive each SRS as if the UE 115 transmitted each SRS from the same beam, even if the UE 115 may use multiple different beams to transmit the SRSs. In some cases, the UE 115 may use a set of multiple beams to transmit the SRSs. In some examples, the UE 115 may transmit each SRS of an SRS resource set occasion 310 on a different beam or the UE 115 may transmit all the SRSs of a respective SRS resource set occasion 310 using the same beam and use different beams for each respective SRS resource set occasion 310 of the respective SRS resource set burst 315.

In some examples, the network entity 105 may indicate the common transmit spatial filter or to use a common transmit spatial filter via the control signaling (e.g., control signaling 220 with reference to FIG. 2) transmitted to the UE 115 prior to the UE 115 transmitting the SRSs. Additionally, such control signaling may enable the UE 115 to transmit SRS resource set level repetitions as opposed to symbol level SRS repetitions. In some examples, the network entity 105 may transmit the control signaling via an RRC message. The RRC message may indicate a time domain usage for the SRS resource set occasions 310. In some cases, when the UE 115 is configured with the RRC time domain prediction usage and with both the first periodicity 320 and second periodicity 325, the RRC usage may indicate that the UE 115 is to use a common transmit spatial filter for each respective SRS in each SRS resource set 305 within a respective SRS resource set burst 315, for each respective SRS in each respective SRS resource set burst 315, or both. For instance, a SRS resource set may be associated with a RRC configured usage (e.g., TDprediction). In such cases, that if the first and the second periodicities are both configured with a SRS resource set with usage configured as TDprediction, the UE 115 may use a common transmit spatial filter for the same SRS resource but different SRS resource set occasions within the same SRS resource. In some cases, when the first and the second periodicities are both configured with a SRS resource set, the RRC message may include an RRC flag, instead of the time domain prediction usage, to indicate for the UE 115 to use a common transmit spatial filter for each respective SRS in each SRS resource set 305 within a respective SRS resource set burst 315, for each respective SRS in each respective SRS resource set burst 315, or both.

In some examples, the network entity 105 may transmit the control signaling via a MAC-CE message. In some cases, the MAC-CE message may active the SRS resource sets 305 and further indicate whether the UE 115 is to use a common transmit spatial filter for each respective SRS in each SRS resource set 305 within a respective SRS resource set burst 315, for each respective SRS in each respective SRS resource set burst 315, or both. In some cases, for semi-periodic SRS resource sets, the UE 115 may receive a first MAC-CE message activating the SRS resource sets 305 and a second MAC-CE message indicating whether the UE 115 is to use a common transmit spatial filter for each respective SRS in each SRS resource set 305 within a respective SRS resource set burst 315, for each respective SRS in each respective SRS resource set burst 315, or both. In some examples, the MAC-CE may include an SRS resource set 305 ID. The SRS resource set 305 ID may point to the SRS resource set 305-a to indicate that all the other SRS resource sets 305 (e.g., the SRS resource set 305-b, the SRS resource set 305-c) within the SRS resource set burst 315-a use the same transmit spatial filter that the UE 115 uses to transmit the SRS resource set 305-a.

In some examples, the network entity 105 may transmit the control signaling via a downlink control information (DCI) message. In some cases, the DCI may be a downlink-grant DCI as there may be some resources for feedback (e.g., acknowledgements (ACK) and negative ACKs (NACK). The DCI message may indicate whether the UE 115 is to use a common transmit spatial filter for each respective SRS in each SRS resource set 305 within a respective SRS resource set burst 315, for each respective SRS in each respective SRS resource set burst 315, or both. Similarly to the MAC-CE signaling, in some cases, the DCI may also include an SRS resource set 305 ID.

In addition to indicating the how the UE 115 is to use the common transmit spatial filter, the control signaling may also indicate the first periodicity 320 and the second periodicity 325. In some examples, the RRC configuration of the SRS resource sets may further include multiple candidate options for the first periodicity 320 and the second periodicity 325 (e.g., {P₁, P₂}). Further, if a MAC-CE activates one or more SRS resource sets 305, the MAC-CE may also include an option-ID to indicate which of the multiple candidate options to select. In some examples, a dedicated MAC-CE separate from the MAC-CE used to activate the SRS resource sets 305 may be used to indicate one of the multiple candidate options via the option-ID. In cases where the UE 115 may be waiting for the indication of one of the multiple candidate options, the network entity 105 may allocate one of the options for both the first periodicity 320 and the second periodicity 325 as default options. As such, if the network entity 105 determines to use the default options, the network entity 105 may refrain from transmitting the dedicated MAC-CE with an associated option-ID to reduce signaling overhead. In some examples, when the RRC configuration of the SRS resource sets 305 includes the multiple candidate options, a DCI message may indicate which option to use. As such, the DCI (e.g., a downlink-grant DCI with ACK/NACK availability) may include an option-ID along with a SRS resource set ID to indicate the option for the first periodicity 320 and second periodicity 325.

Such techniques may apply for single periodic and semi-periodic SRS resource sets 305. The techniques described may enable the network entity 105 to perform more accurate uplink transmission beam predictions. In some cases, the network entity 105 may predict future uplink transmission beams in-between SRS resource set bursts 315. For example, after the SRS resource set burst 315-a, the network entity 105 may predict the uplink transmission beams for the SRS resource set burst 315-b. Having the UE 115 use the same spatial filter across SRSs in the SRS resource set burst 315-a may support the network entity 105 performing more accurate measurements resulting in more accurate uplink transmission beam predictions.

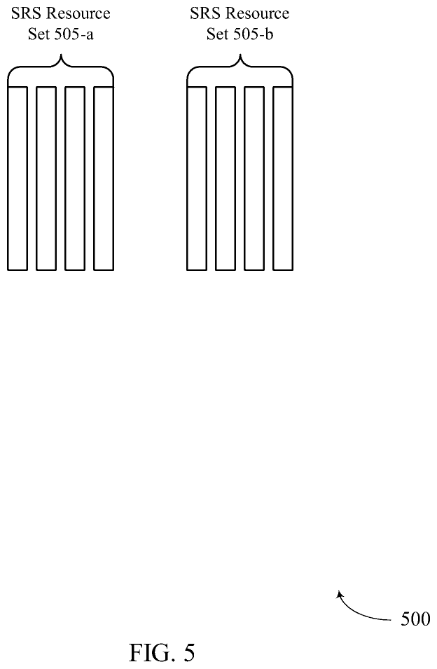

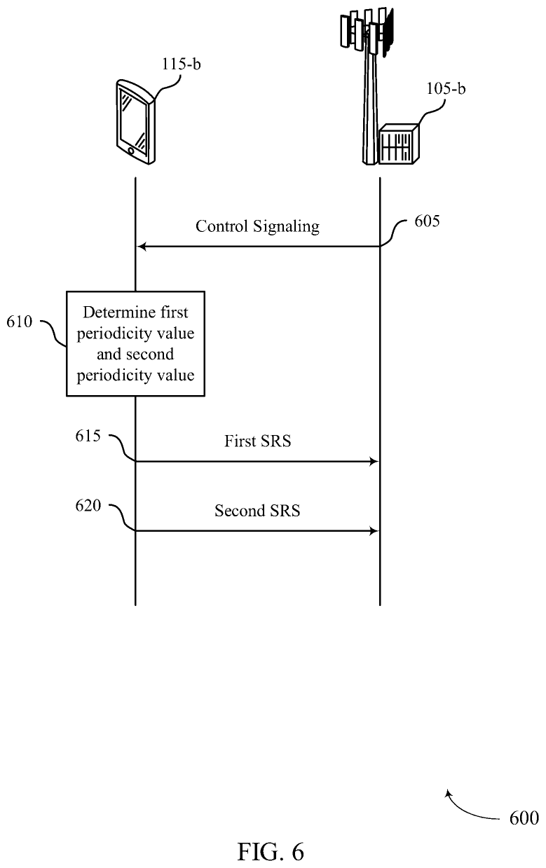

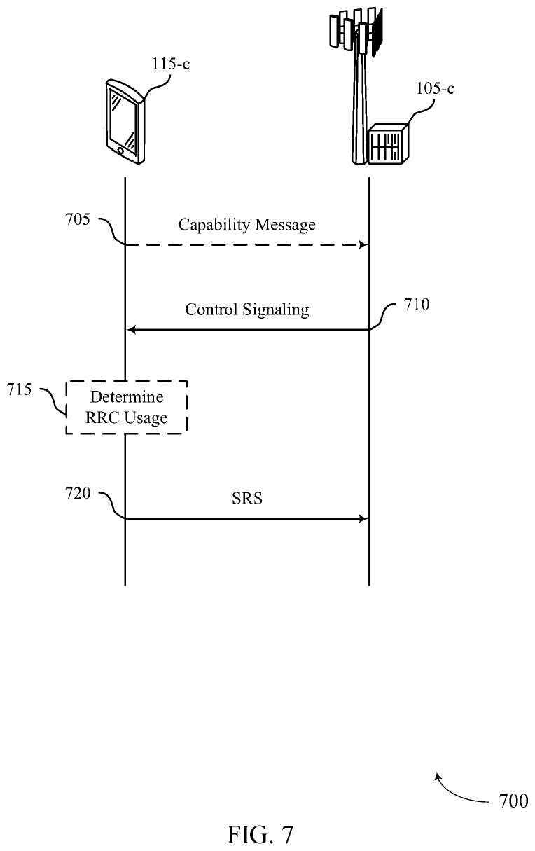

Further techniques to support the network entity 105 in generating accurate uplink transmission beam predictions may be described elsewhere herein. Techniques for multiple periodic and semi-periodic SRS resource sets 305 is described with reference to FIG. 4. Techniques for aperiodic SRS resource sets 305 is described with reference to FIG. 5. Further techniques of the present disclosure is described elsewhere herein, including with reference to FIGS. 6 and 7.

FIG. 4 shows an example of a resource allocation 400 that supports techniques for SRS resource set repetition in accordance with one or more aspects of the present disclosure. In some examples, the resource allocation 400 may implement or be implemented by the wireless communications system 100 or the wireless communications system 200. For example, the resource allocation 400 illustrates examples of SRS resource sets 405 (e.g., SRS resource set 405-a, SRS resource set 405-b, and SRS resource set 405-c) to be transmitted from a UE 115 to a network entity 105. In some cases, the network entity 105 may signal the configuration illustrated in FIG. 4 to the UE 115 via a control signaling (e.g., the control signaling 220 with reference to FIG. 2) as illustrated with reference to FIG. 2.

In some examples, a SRS resource set 405 may be RRC configured with a time domain prediction usage. Additionally, in some cases, a group of multiple SRS resource sets 405, each including a same quantity of SRSs (e.g., four SRSs), may be associated with each other. In such cases, the UE 115 may transmit each SRS of the SRS resource set 405-a, the SRS resource set 405-b, and the SRS resource set 405-c using the same common transmit spatial filter. That is, the network entity 105 may receive the SRSs from the SRS resource sets 405 as the UE 115 transmitted each SRS using the same beam. In some examples, such common transmit spatial filter may be indicated by the network entity 105 via some control signaling.

Additionally, or alternatively, an RRC configured spatial relation information (e.g., SRS-SpatialRelationInfo(s)) of the SRS in the SRS resource set 405-a and the RRC configured spatial relation information of the SRS of the SRS resource set 405-b and the SRS resource set 405-c may be the same. That is, the SRS of each of the SRS resource sets 405 may be spatially related to each other. For example, each SRS resource set 405 may include four SRSs (e.g., a first SRS, a second SRS, a third SRS, and a fourth SRS) and each SRS of each SRS resource set 405 may be related to each other. As illustrated in FIG. 4 with the curved arrows, the first SRS of the SRS resource set 405-b and the first SRS of the SRS resource set 405-c may be associated with the first SRS of the SRS resource set 405-a. Further, the second SRS, the third SRS, and the fourth SRS of the SRS resource set 405-b and the SRS resource set 405-c may be associated with the second SRS, the third SRS, and the fourth SRS of the SRS resource set 405-a. As such, each SRS of the SRS resource set 405-b and the SRS resource set 405-c may be associated with each SRS of the SRS resource set 405-a, therefore each SRS of the SRS resource set 405-b may be associated with each SRS of the SRS resource set 405-c, and vice versa. Thus, the SRS resource set 405-a, the SRS resource set 405-b, and the SRS resource set 405-c may each be associated with each other based on the associations with the SRSs of the SRS resource set 405-a

In some cases, each respective associated SRS resource set 405 may include SRS resource set IDs of the SRS resource sets 405 associated with the respective SRS resource set 405. For example, the SRS resource set 405-b may include the SRS resource set IDs of the SRS resource set 405-a and the SRS resource set 405-c. As such, when the UE 115 transmits the SRS resource set 405-b to the network entity 105, the network entity 105 may be able to determine that the SRSs of the SRS resource set 405-b may be associated with the SRSs of the SRS resource set 405-a and the SRS resource set 405-c, which has yet to be received. In some cases, each respective associated SRS resource set 405 may include a group-ID. As such, when the UE 115 transmits the SRS resource sets 405, the network entity 105 may determine that each SRS resource set 405 with the same group-ID may be associated with each other. Additionally, or alternatively, each respective associated SRS resource set 405 may include both the SRS resource set IDs of the SRS resource sets 405 associated with the respective SRS resource set 405 and the group-ID for the group of associated SRS resource set 405.

To aid the network entity 105 in inferring such associations, the UE 115 may transmit a capability message. The capability message may indicate a maximum quantity of configurable SRS resource sets 405, a maximum quantity of SRSs per SRS resource set 405, or both. In some cases, the RRC usage of the SRS resource set 405 may not be applicable in the case where the UE 115 may transmit separate capability messages indicating a maximum quantity of configurable SRS resource set 405 groups and indicating the maximum quantity of SRS in each SRS resource set 405.

Additionally, or alternatively, the time domain prediction RRC usage may be a sub-usage of a beam management usage (e.g., beamManagement). In such cases, the UE 115 may count or otherwise determine each SRS resource set 405 with the time domain prediction usage that is also associated with each other to form a virtual SRS resource set 405. The quantity of SRSs within the virtual SRS resource set 405 may be equal or the same as the quantity of SRSs in each associated SRS resource set 405 (e.g., the SRS resource set 405-a, the SRS resource set 405-b, and the SRS resource set 405-c). As such, the UE 115 may generate and transmit the virtual SRS resource set 405 to the network entity 105 to reduce latency and signaling overhead. Since each SRS of the SRS resource set 405-a, the SRS resource set 405-b, and the SRS resource set 405-c may be associated with each other, instead of transmitting each SRS resource set 405 separately the UE 115 may transmit the virtual SRS resource set 405 to the network entity 105 which may give the same results as if the UE 115 each the SRS resource set 405 separately. In some cases, instead of using the time domain prediction usage within each associated SRS resource set 405, a sub information element (sub-IE) or RRC flag may indicate to the UE 115 that the counting of the consumed quantity of a SRS resource set 405 is equal to one across all the associated SRS resource sets 405.

The virtual SRS resource set 405 may allow the UE 115 to transmit multiple SRS resource sets 405 together, therefore reducing the signaling overhead compared to transmitting the SRS resource set 405-a, the SRS resource set 405-b, and the SRS resource set 405-c separately. In some cases, the UE 115 may transmit the SRS resource sets 405 or the virtual SRS resource set 405 periodically or semi-periodically as configured by the network entity 105. In some cases, the UE 115 may transmit the SRS resource sets 405 aperiodically. Aperiodic transmission of the SRS resource sets 405 is further described with reference to FIG. 5.

FIG. 5 shows an example of a resource allocation 500 that supports techniques for SRS resource set repetition in accordance with one or more aspects of the present disclosure. In some examples, the resource allocation 500 may implement or be implemented by the wireless communications system 100 or the wireless communications system 200. For example, the resource allocation 500 illustrates examples of SRS resource sets 505 (e.g., SRS resource set 505-a and SRS resource set 505-b) to be transmitted from a UE 115 to a network entity 105. The SRS resource set 505-a may represent a previous SRS resource set 505 and the SRS resource set 505-b may represent a current or future SRS resource set 505. In some cases, the network entity 105 may signal the configuration illustrated in FIG. 5 to the UE 115 via a control signaling (e.g., the control signaling 220 with reference to FIG. 2) as illustrated with reference to FIG. 2.

When the network entity 105 aperiodically triggers the UE 115 to transmit a SRS resource set 505 (e.g., the SRS resource set 505-b), the network entity 105 may further indicate whether the uplink transmit spatial filter associated with the SRSs of the SRS resource set 505-b is the same as the uplink transmit spatial filter used by the UE 115 to transmit the SRS resource set 505-a. For example, the network entity 105 may transmit a DCI message triggering the UE 115 to transmit the SRS resource set 505-b. In some cases, the DCI message may have an SRS request field which may be the trigger for the UE 115 to transmit the SRS resource set 505-b. In some examples, a field with a bit with a value of 1 may represent that the UE 115 is to transmit the SRS resource set 505-b, and a bit with a value of 0 may represent that the UE 115 is to refrain from transmitting the SRS resource set 505-b, or vice versa. In some cases, the UE 115 may be triggered by dedicated bits of the DCI separate from the SRS request field. For example, there may be a single dedicated bit that indicate that all aperiodic SRS resource sets 505 triggered by the DCI are to follow the same indication (e.g., use a common uplink transmit spatial filter) or there may multiple dedicated bits where different SRS resource sets 505 triggered may include their own indications.

In some examples, the UE 115 receive separate DCIs indicating whether the uplink transmit spatial filter associated with the SRSs of the SRS resource set 505-b is the same as the uplink transmit spatial filter used by the UE 115 to transmit the SRS resource set 505-a from the DCI that triggers the UE 115 to transmit the SRS resource set 505-b. As such, the indication in the separate DCI may be applied until the UE 115 receives a DCI indicating otherwise. For example, if the separate DCI indicates that the UE 115 may apply the same uplink transmit spatial filter as the one used for transmitting the SRS resource set 505-a to each SRS resource set 505 transmitted, the UE 115 may follow such indication until the UE 115 received a DCI indicating to use a different uplink transmit spatial filter, or vice versa. That is, the UE 115 may be aperiodically configured with whether the uplink transmit spatial filter from the previous SRS resource set 505 is to be applied to transmitting the following or next SRS resource set 505.

In some examples, the UE 115 may receive a MAC-CE message indicating whether the uplink transmit spatial filter associated with the SRSs of the SRS resource set 505-b is the same as the uplink transmit spatial filter used by the UE 115 to transmit the SRS resource set 505-a. As such, this dedicated MAC-CE may semi-statically control this indication. In some cases, the MAC-CE may include respective indications to use for different RRC configured SRS resource sets 505. For example, the MAC-CE may indicate to use the same uplink transmit spatial filter for all SRS resource sets 505 with the same RRC usage. That is, if the SRS resource set 505-a is configured with the time domain prediction RRC usage and the SRS resource set 505-b is also configured with the time domain prediction RRC usage, the UE 115 may use the same uplink transmit spatial filter used by the UE 115 to transmit the SRS resource set 505-a for transmitting the SRS resource set 505-b. Alternatively, the SRS resource set 505-a and the SRS resource set 505-b may be configured with different RRC usages and the UE 115 may use different uplink transmit spatial filters between the SRS resource set 505-a and the SRS resource set 505-b based on the indication from the MAC-CE.

Additionally, or alternatively, the UE 115 may apply such indications from the MAC-CE a quantity of milliseconds after the UE 115 transmits an ACK to the network entity 105 regarding reception of the MAC-CE. In some cases, the quantity of milliseconds may be indicated in the initial control signaling from the network entity 105 to the UE 115 or it may be predefined between the two devices. Further, when the UE 115 transmits the SRS resource set level repetitions based on the aperiodic indications described herein, the UE 115 may ignore or refrain from considering the TCI states (e.g., with Type-D QCL), spatial relation information (e.g., SRS-SpatialRelationInfo), or the CSI-RSs (e.g., associatedCSI-RS) associated with the SRSs of the SRS resource sets 505. Further descriptions of transmitting SRS resource sets 505 periodically and semi-periodically may be described elsewhere herein, including with reference to FIGS. 6 and 7.

FIG. 6 shows an example of a process flow 600 that supports techniques for SRS resource set repetition in accordance with one or more aspects of the present disclosure. In some examples, the process flow 600 may implement or be implemented by the wireless communications system 100 or the wireless communications system 200. For example, the process flow 600 may include a UE 115-b and a network entity 105-b, which may be examples of devices described herein with reference to FIGS. 1-2.

In the following description of the process flow 600, the operations between the UE 115-b and the network entity 105-b may be performed in different orders or at different times. Some operations may also be left out of the process flow 600, or other operations may be added. Although the UE 115-b and the network entity 105-b are shown performing the operations of the process flow 600, some aspects of some operations may also be performed by one or more other wireless devices.

At 605, the UE 115-b may receive control signaling, from the network entity 105-b, indicating a first time domain periodicity value for transmitting a first SRS resource set burst via a set of SRS resource set occasions. The UE 115-b may transmit a first SRS resource set in a first SRS resource set occasion of the set of SRS resource set occasions and a second SRS resource set in a second SRS resource set occasion, to the network entity 105-b, in accordance with the first time domain periodicity value. The control signaling may also indicate a second time domain periodicity value for transmitting a set of SRS resource set bursts including the first SRS resource set burst and a second SRS resource set bust. The UE 115-b may transmit the first SRS resource set burst and the second SRS resource set burst in accordance with the second time domain periodicity value.

At 610, the UE 115-b may determine a first periodicity for transmitting SRS resource set occasions within an SRS resource set burst from the first periodicity value and a second periodicity for transmitting the SRS resource set bursts from the second periodicity value.

In some examples, at 605, the UE 115-b may receive an RRC message, from the network entity 105-b, including the control signaling. The RRC message may indicate a time domain prediction usage for the set of SRS resource set occasions. In some cases, the RRC message may include an indication to apply a common transmit spatial filter to a respective SRS in each of a set of SRS resource sits in a set of SRS resource occasions, to apply a common transmit spatial filter to a respective SRS in each of a set of SRS resource set bursts, or both. In some cases, the RRC message may include an RRC flag indicating to apply a common transmit spatial filter to a respective SRS in each of a set of SRS resource sits in a set of SRS resource occasions, to apply a common transmit spatial filter to a respective SRS in each of a set of SRS resource set bursts, or both.

In some examples, the UE 115-b may receive a MAC-CE message, from the network entity 105-b, activating a set of SRS resource sets including the first SRS resource set and the second SRS resource set. The MAC-CE message may indicate whether to apply a common transmit spatial filter is to a respective SRS in each of the set of SRS resource sets, whether to apply a common transmit spatial filter is to a respective SRS in each of a set of SRS resource set bursts, or both. In some cases, the UE 115-b may receive a first MAC-CE message, from the network entity 105-b, activating the set of SRS resource sets including the first SRS resource set and the second SRS resource set. The UE 115-b may also receive a second MAC-CE message, from the network entity 105-b, indicating one or more SRS resource set IDs. The second MAC-CE message may also indicate whether to apply a common transmit spatial filter to a respective SRS in each of the set of SRS resource sets, whether to apply a common transmit spatial filter to a respective SRS in each of a set of SRS resource set bursts, or both.

In some examples, the UE 115-b may receive a DCI message, from the network entity 105-b including the control signaling. The DCI message may indicate whether to apply a common transmit spatial filter to a respective SRS in each of the set of SRS resource sets, whether to apply a common transmit spatial filter to a respective SRS in each of a set of SRS resource set bursts, or both. In some cases, the DCI message may also include a SRS resource set ID with the indication of the common transmit spatial filter.

In some cases, the control signaling may include a first control signal and a second control signal. The first control signal may indicate a set of candidate options for the first time domain periodicity value and the second time domain periodicity value. In some cases, the set of candidate options may be associated with a set of option IDs where each option ID is associated with a corresponding candidate option. The second control signal may activate a set of SRS resource sets including the first SRS resource set and the second SRS resource set. Additionally, the second control signal may also include an option ID from the set of option IDs, the option ID associated with one of the candidate options of the set of candidate options.

At 615, the UE 115-b may transmit a first SRS via the first SRS resource set, to the network entity 105-b, and at 620, the UE 115-b may transmit a second SRS via the second SRS resource set, to the network entity 105-b, in accordance with the first time domain periodicity value. In some cases, the second SRS may be the first SRS in the second SRS resource set. The UE 115-b may transmit the first SRS at 615 and the UE 115-b may transmit the second SRS at 620 using a common transmit spatial filter, the common transmit spatial filter being based on the control signaling.

In some cases, at 615, the UE 115-b may transmit a first SRS via the first SRS resource set burst, to the network entity 105-b and at 620, the UE 115-b may transmit a first SRS via the second SRS resource set burst, to the network entity 105-b, using a common transmit spatial filter. That is, the UE 115-b may transmit the first SRS resource set burst and the second SRS resource set burst using the same common transmit spatial filter.

In some cases, at 615, the UE 115-b may transmit a first SRS via the first SRS resource set burst, to the network entity 105-b, using a first transmit spatial filter and at 620, the UE 115-b may transmit a first SRS via the second SRS resource set burst, to the network entity 105-b, using a second transmit spatial filter that is different than the first transmit spatial filter. That is, the UE 115-b may transmit the first SRS resource set burst and the second SRS resource set burst using different transmit spatial filters.

FIG. 7 shows an example of a process flow 700 that supports techniques for SRS resource set repetition in accordance with one or more aspects of the present disclosure. In some examples, the process flow 700 may implement or be implemented by the wireless communications system 100 or the wireless communications system 200. For example, the process flow 700 may include a UE 115-c and a network entity 105-c, which may be examples of devices described herein with reference to FIGS. 1-2.

In the following description of the process flow 700, the operations between the UE 115-c and the network entity 105-c may be performed in different orders or at different times. Some operations may also be left out of the process flow 700, or other operations may be added. Although the UE 115-c and the network entity 105-c are shown performing the operations of the process flow 700, some aspects of some operations may also be performed by one or more other wireless devices

At 705, in some examples, the UE 115-c may optionally transmit a capability message, to the network entity 105-c, indicating a maximum quantity of SRS resource sets in a set of SRS resource sets, a maximum quantity of SRS for each SRS resource set of the set of SRS resource sets, or both.

At 710, the UE 115-c may receive control signaling, from the network entity 105-c, indicating the set of SRS resource sets including at least a first SRS resource set and a second SRS resource set. Each SRS resource set of the set of SRS resource sets may include a same quantity of SRSs. In some cases, the control signaling may indicate whether to apply a common transmit spatial filter to a respective SRS in each of the set of SRS resource sets. In some examples, the UE 115-c may receive a RRC message including the control signaling, from the network entity 105-c. In some cases, the RRC message may indicate a time domain prediction usage of the set of SRS resource sets. In some cases, the time domain prediction usage of the RRC message may be a sub-usage of a beam management usage. In some examples, at 715, the 115-c may determine that usage of the RRC message.

At 720, the UE 115-c may transmit a first SRS via the first SRS resource set and a second SRS via the second SRS resource set using a common transmit spatial filter, where control signaling may indicate the common transmit spatial filter. In some examples, the first SRS in the second SRS set is associated with the first SRS in the first SRS set. In some cases, each SRS resource set of the set of SRS resource sets may include a SRS resource set ID indicating that that SRS resource set may be associated with the first SRS resource set. In some cases, each SRS resource set of the set of SRS resource set may include a group-ID indicating that the SRS resource set may be associated with a group of SRS resource sets. In some examples, each respective SRS resource set of the group of SRS resource sets may be associated with each other.

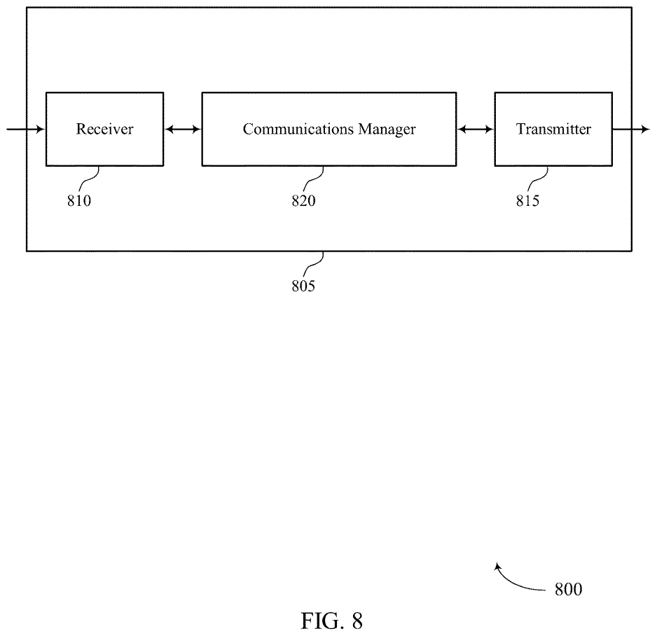

FIG. 8 shows a block diagram 800 of a device 805 that supports techniques for SRS resource set repetition in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for SRS resource set repetition). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for SRS resource set repetition). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for SRS resource set repetition as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. For example, the communications manager 820 is capable of, configured to, or operable to support a means for receiving control signaling indicating a first time domain periodicity value for transmitting a first SRS resource set burst via a set of multiple SRS resource set occasions, where a first SRS resource set in a first SRS resource set occasion of the set of multiple SRS resource set occasions and a second SRS resource set in a second SRS resource set occasion of the set of multiple SRS resource set occasions are to be transmitted in accordance with the first time domain periodicity value. The communications manager 820 is capable of, configured to, or operable to support a means for transmitting, in accordance with the first time domain periodicity value, a first SRS via the first SRS resource set and a second SRS via the second SRS resource set using a common transmit spatial filter based on the control signaling.

Additionally, or alternatively, the communications manager 820 may support wireless communication at a UE in accordance with examples as disclosed herein. For example, the communications manager 820 is capable of, configured to, or operable to support a means for receiving control signaling indicating a set of multiple SRS resource sets including at least a first SRS resource set and a second SRS resource set, where each SRS resource set includes a same quantity of SRSs. The communications manager 820 is capable of, configured to, or operable to support a means for transmitting a first SRS via the first SRS resource set and a second SRS via the second SRS resource set using a common transmit spatial filter based on the control signaling.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for transmitting SRS resource set repetitions for reduced processing, reduced power consumption, and more efficient utilization of communication resources.

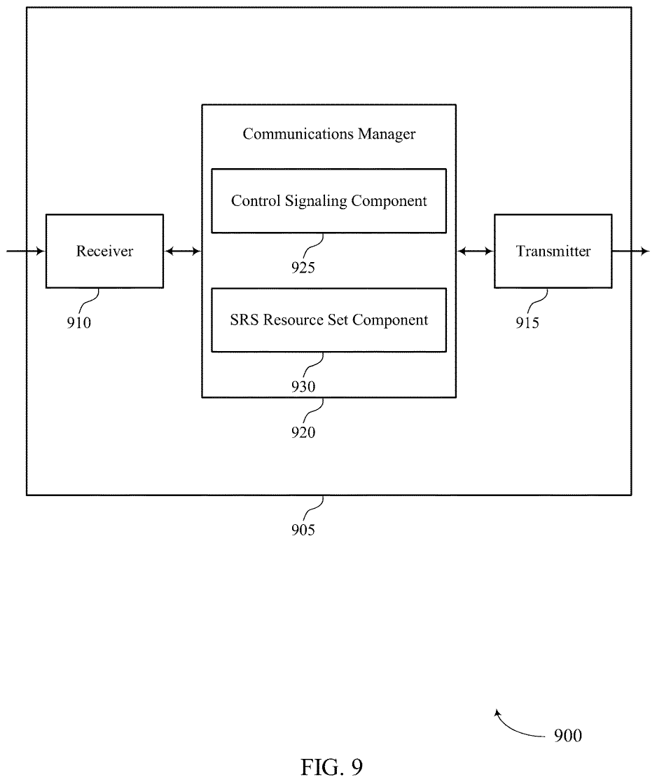

FIG. 9 shows a block diagram 900 of a device 905 that supports techniques for SRS resource set repetition in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for SRS resource set repetition). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for SRS resource set repetition). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for SRS resource set repetition as described herein. For example, the communications manager 920 may include a control signaling component 925 an SRS resource set component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE in accordance with examples as disclosed herein. The control signaling component 925 is capable of, configured to, or operable to support a means for receiving control signaling indicating a first time domain periodicity value for transmitting a first SRS resource set burst via a set of multiple SRS resource set occasions, where a first SRS resource set in a first SRS resource set occasion of the set of multiple SRS resource set occasions and a second SRS resource set in a second SRS resource set occasion of the set of multiple SRS resource set occasions are to be transmitted in accordance with the first time domain periodicity value. The SRS resource set component 930 is capable of, configured to, or operable to support a means for transmitting, in accordance with the first time domain periodicity value, a first SRS via the first SRS resource set and a second SRS via the second SRS resource set using a common transmit spatial filter based on the control signaling.

Additionally, or alternatively, the communications manager 920 may support wireless communication at a UE in accordance with examples as disclosed herein. The control signaling component 925 is capable of, configured to, or operable to support a means for receiving control signaling indicating a set of multiple SRS resource sets including at least a first SRS resource set and a second SRS resource set, where each SRS resource set includes a same quantity of SRSs. The SRS resource set component 930 is capable of, configured to, or operable to support a means for transmitting a first SRS via the first SRS resource set and a second SRS via the second SRS resource set using a common transmit spatial filter based on the control signaling.

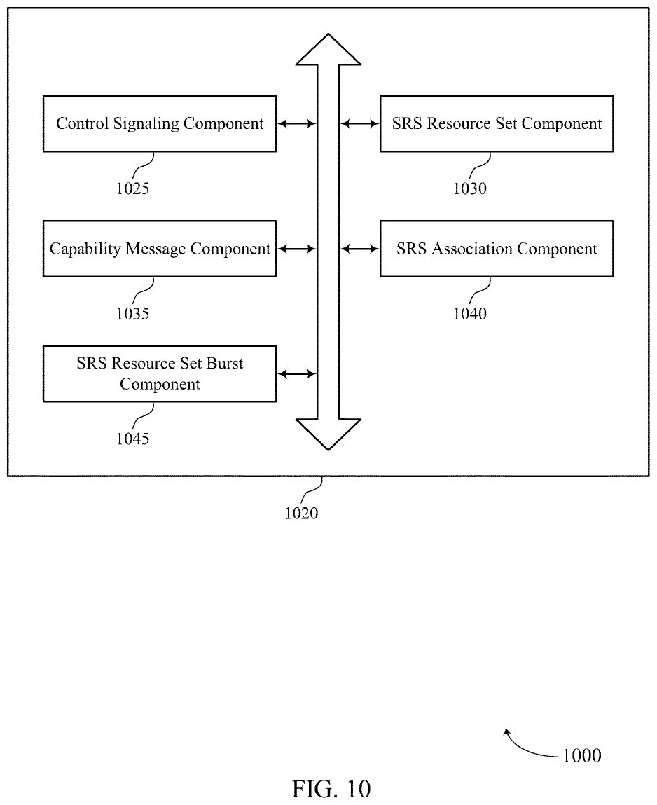

FIG. 10 shows a block diagram 1000 of a communications manager 1020 that supports techniques for SRS resource set repetition in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for SRS resource set repetition as described herein. For example, the communications manager 1020 may include a control signaling component 1025, an SRS resource set component 1030, a capability message component 1035, an SRS association component 1040, an SRS resource set burst component 1045, or any combination thereof. Each of these components may communicate, directly or indirectly, with one another (e.g., via one or more buses).

The communications manager 1020 may support wireless communication at a UE in accordance with examples as disclosed herein. The control signaling component 1025 is capable of, configured to, or operable to support a means for receiving control signaling indicating a first time domain periodicity value for transmitting a first SRS resource set burst via a set of multiple SRS resource set occasions, where a first SRS resource set in a first SRS resource set occasion of the set of multiple SRS resource set occasions and a second SRS resource set in a second SRS resource set occasion of the set of multiple SRS resource set occasions are to be transmitted in accordance with the first time domain periodicity value. The SRS resource set component 1030 is capable of, configured to, or operable to support a means for transmitting, in accordance with the first time domain periodicity value, a first SRS via the first SRS resource set and a second SRS via the second SRS resource set using a common transmit spatial filter based on the control signaling.

In some examples, to support receiving the control signaling, the control signaling component 1025 is capable of, configured to, or operable to support a means for receiving an indication of a second time domain periodicity value for transmitting a set of multiple SRS resource set bursts including the first SRS resource set burst and a second SRS resource set burst, where the first SRS resource set burst and the second SRS resource set burst are to be transmitted in accordance with the second time domain periodicity value.

In some examples, the SRS resource set burst component 1045 is capable of, configured to, or operable to support a means for transmitting, in accordance with the second time domain periodicity value, a first SRS via the first SRS resource set burst and a first SRS via the second SRS resource set burst using a common transmit spatial filter.

In some examples, the SRS resource set burst component 1045 is capable of, configured to, or operable to support a means for transmitting, in accordance with the second time domain periodicity value, a first SRS via the first SRS resource set burst using a first transmit spatial filter and a first SRS via the second SRS resource set burst using a second transmit spatial filter that is different than the first transmit spatial filter.

In some examples, to support receiving the control signaling, the control signaling component 1025 is capable of, configured to, or operable to support a means for receiving a radio resource control message including the control signaling, the radio resource control message indicating a time domain prediction usage of the set of multiple SRS resource set occasions.

In some examples, the radio resource control message includes an indication of the common transmit spatial filter applied to a respective SRS in each of a set of multiple SRS resource sets, a common transmit spatial filter applied to a respective SRS in each of a set of multiple SRS resource set bursts, or both.

In some examples, the radio resource control message includes a radio resource control flag indicating whether the common transmit spatial filter is to be applied to a respective SRS in each of a set of multiple SRS resource sets, whether a common transmit spatial filter is to be applied to a respective SRS in each of a set of multiple SRS resource set bursts, or both.

In some examples, to support receiving the control signaling, the control signaling component 1025 is capable of, configured to, or operable to support a means for receiving a medium access control channel element message activating a set of multiple SRS resource sets including the first SRS resource set and the second SRS resource set, where the medium access control channel element message indicates whether the common transmit spatial filter is to be applied to a respective SRS in each of the set of multiple SRS resource sets, whether a common transmit spatial filter is to be applied to a respective SRS in each of a set of multiple SRS resource set bursts, or both.

In some examples, to support receiving the control signaling, the control signaling component 1025 is capable of, configured to, or operable to support a means for receiving a first medium access control channel element message activating a set of multiple SRS resource sets including the first SRS resource set and the second SRS resource set. In some examples, to support receiving the control signaling, the control signaling component 1025 is capable of, configured to, or operable to support a means for receiving a second medium access control channel element message indicating one or more SRS resource set IDs, where the second medium access control channel element message indicates whether the common transmit spatial filter is to be applied to a respective SRS in each of the set of multiple SRS resource sets, whether a common transmit spatial filter is to be applied to a respective SRS in each of a set of multiple SRS resource set bursts, or both.

In some examples, to support receiving the control signaling, the control signaling component 1025 is capable of, configured to, or operable to support a means for receiving a downlink control information message including the control signaling, the downlink control information message indicating whether the common transmit spatial filter is to be applied to a respective SRS in each of a set of multiple SRS resource sets, whether a common transmit spatial filter is to be applied to a respective SRS in each of a set of multiple SRS resource set bursts, or both.

In some examples, the downlink control information message includes a SRS resource set ID and indicates whether the common transmit spatial filter is to be applied to a respective SRS in each of the set of multiple SRS resource sets, whether a common transmit spatial filter is to be applied to a respective SRS in each of the set of multiple SRS resource set bursts, or both, based on the SRS resource set ID.

In some examples, to support receiving the control signaling, the control signaling component 1025 is capable of, configured to, or operable to support a means for receiving a first control signal indicating a set of multiple candidate options for the first time domain periodicity value and a second time domain periodicity value, where the set of multiple candidate options are associated with a set of multiple option IDs. In some examples, to support receiving the control signaling, the control signaling component 1025 is capable of, configured to, or operable to support a means for receiving a second control signal activating a set of multiple SRS resource sets including the first SRS resource set and the second SRS resource set, the second control signal including an option ID from set of multiple option IDs.

Additionally, or alternatively, the communications manager 1020 may support wireless communication at a UE in accordance with examples as disclosed herein. In some examples, the control signaling component 1025 is capable of, configured to, or operable to support a means for receiving control signaling indicating a set of multiple SRS resource sets including at least a first SRS resource set and a second SRS resource set, where each SRS resource set includes a same quantity of SRSs. In some examples, the SRS resource set component 1030 is capable of, configured to, or operable to support a means for transmitting a first SRS via the first SRS resource set and a second SRS via the second SRS resource set using a common transmit spatial filter based on the control signaling.

In some examples, the control signaling indicates whether the common transmit spatial filter is to be applied to a respective SRS in each of the set of multiple SRS resource sets.

In some examples, to support receiving the control signaling, the control signaling component 1025 is capable of, configured to, or operable to support a means for receiving a radio resource control message including the control signaling, the radio resource control message indicating a time domain prediction usage of a set of multiple SRS resource set occasions.

In some examples, the usage of the radio resource control message is a sub usage of a beam management usage.

In some examples, each SRS resource set with the usage of time domain predication is associated with each other in accordance with a single virtual SRS resource set, and where a quantity of SRSs within the single virtual SRS resource set is based on a quantity of SRSs within each associated SRS resource set.

In some examples, the capability message component 1035 is capable of, configured to, or operable to support a means for transmitting a capability message indicating a maximum number of SRS resource sets in the set of multiple SRS resource sets, a maximum number of SRSs for each SRS resource set of the set of multiple SRS resource sets, or both.

In some examples, the first SRS in the second SRS set is associated with the first SRS in the first SRS set. In some examples, each SRS resource set of the set of multiple SRS resource sets includes a SRS resource set ID indicating that the SRS resource set is associated with the first SRS resource set.

In some examples, each SRS resource set of the set of multiple SRS resource sets includes a group ID indicating that the SRS resource set is associated with a group of SRS resource sets.

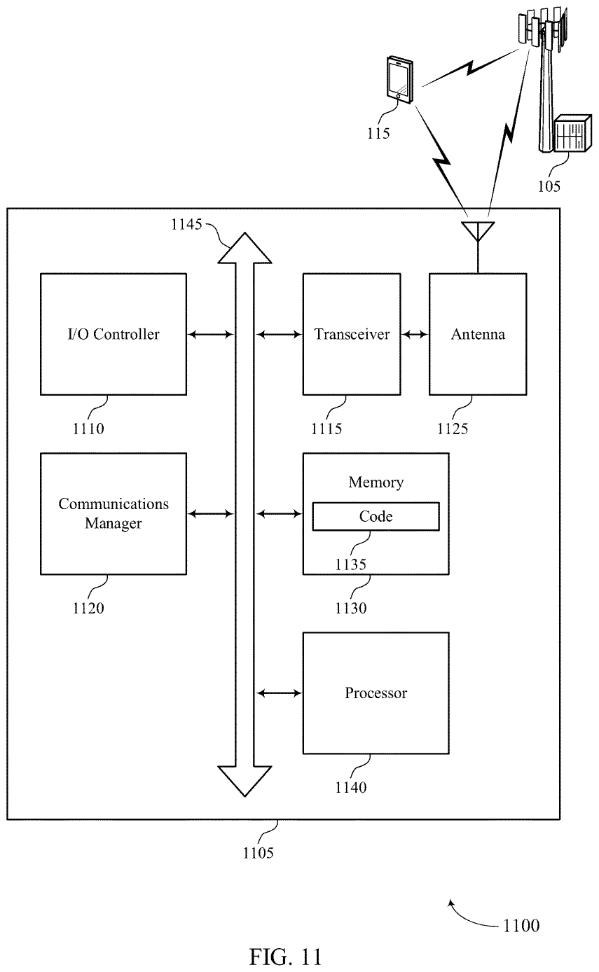

FIG. 11 shows a diagram of a system 1100 including a device 1105 that supports techniques for SRS resource set repetition in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for SRS resource set repetition). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a UE in accordance with examples as disclosed herein. For example, the communications manager 1120 is capable of, configured to, or operable to support a means for receiving control signaling indicating a first time domain periodicity value for transmitting a first SRS resource set burst via a set of multiple SRS resource set occasions, where a first SRS resource set in a first SRS resource set occasion of the set of multiple SRS resource set occasions and a second SRS resource set in a second SRS resource set occasion of the set of multiple SRS resource set occasions are to be transmitted in accordance with the first time domain periodicity value. The communications manager 1120 is capable of, configured to, or operable to support a means for transmitting, in accordance with the first time domain periodicity value, a first SRS via the first SRS resource set and a second SRS via the second SRS resource set using a common transmit spatial filter based on the control signaling.

Additionally, or alternatively, the communications manager 1120 may support wireless communication at a UE in accordance with examples as disclosed herein. For example, the communications manager 1120 is capable of, configured to, or operable to support a means for receiving control signaling indicating a set of multiple SRS resource sets including at least a first SRS resource set and a second SRS resource set, where each SRS resource set includes a same quantity of SRSs. The communications manager 1120 is capable of, configured to, or operable to support a means for transmitting a first SRS via the first SRS resource set and a second SRS via the second SRS resource set using a common transmit spatial filter based on the control signaling.

By including or configuring the communications manager 1120 in accordance with examples as described herein, the device 1105 may support techniques for transmitting SRS resource set repetitions for improved communication reliability, reduced latency, improved user experience related to reduced processing, reduced power consumption, more efficient utilization of communication resources, and improved coordination between devices.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for SRS resource set repetition as described herein, or the processor 1140 and the memory 1130 may be otherwise configured to perform or support such operations.

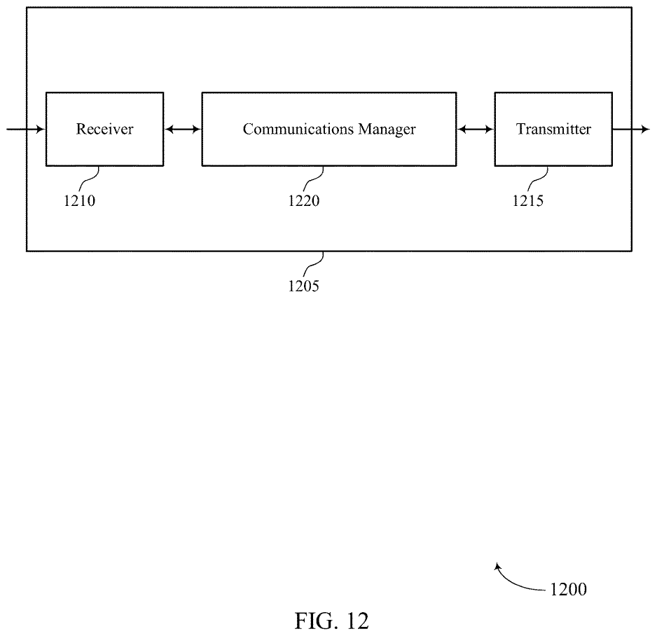

FIG. 12 shows a block diagram 1200 of a device 1205 that supports techniques for SRS resource set repetition in accordance with one or more aspects of the present disclosure. The device 1205 may be an example of aspects of a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of techniques for SRS resource set repetition as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. For example, the communications manager 1220 is capable of, configured to, or operable to support a means for transmitting a control signaling indicating a first time domain periodicity value for transmitting a first SRS resource set burst via a set of multiple SRS resource set occasions, where a first SRS resource set in a first SRS resource set occasion of the set of multiple SRS resource set occasions and a second SRS resource set in a second SRS resource set occasion of the set of multiple SRS resource set occasions are to be received in accordance with the first time domain periodicity value. The communications manager 1220 is capable of, configured to, or operable to support a means for receiving, in accordance with the first time domain periodicity value, a first SRS via the first SRS resource set and a first SRS via the second SRS resource set using a common transmit spatial filter based on the control signaling.

Additionally, or alternatively, the communications manager 1220 may support wireless communications at a network entity in accordance with examples as disclosed herein. For example, the communications manager 1220 is capable of, configured to, or operable to support a means for transmitting control signaling indicating a set of multiple SRS resource sets including at least a first SRS resource set and a second SRS resource set, where each SRS resource set includes a same quantity of SRSs. The communications manager 1220 is capable of, configured to, or operable to support a means for receiving a first SRS via the first SRS resource set and a second SRS via the second SRS resource set using a common transmit spatial filter based on the control signaling.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for transmitting SRS resource set repetitions for reduced processing, reduced power consumption, and more efficient utilization of communication resources.

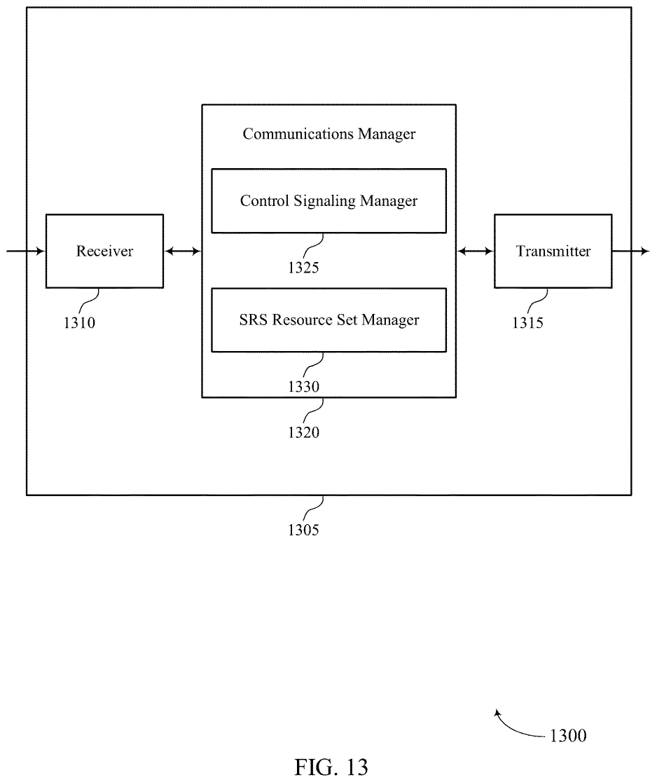

FIG. 13 shows a block diagram 1300 of a device 1305 that supports techniques for SRS resource set repetition in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of techniques for SRS resource set repetition as described herein. For example, the communications manager 1320 may include a control signaling manager 1325 an SRS resource set manager 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a network entity in accordance with examples as disclosed herein. The control signaling manager 1325 is capable of, configured to, or operable to support a means for transmitting a control signaling indicating a first time domain periodicity value for transmitting a first SRS resource set burst via a set of multiple SRS resource set occasions, where a first SRS resource set in a first SRS resource set occasion of the set of multiple SRS resource set occasions and a second SRS resource set in a second SRS resource set occasion of the set of multiple SRS resource set occasions are to be received in accordance with the first time domain periodicity value. The SRS resource set manager 1330 is capable of, configured to, or operable to support a means for receiving, in accordance with the first time domain periodicity value, a first SRS via the first SRS resource set and a first SRS via the second SRS resource set using a common transmit spatial filter based on the control signaling.

Additionally, or alternatively, the communications manager 1320 may support wireless communications at a network entity in accordance with examples as disclosed herein. The control signaling manager 1325 is capable of, configured to, or operable to support a means for transmitting control signaling indicating a set of multiple SRS resource sets including at least a first SRS resource set and a second SRS resource set, where each SRS resource set includes a same quantity of SRSs. The SRS resource set manager 1330 is capable of, configured to, or operable to support a means for receiving a first SRS via the first SRS resource set and a second SRS via the second SRS resource set using a common transmit spatial filter based on the control signaling.

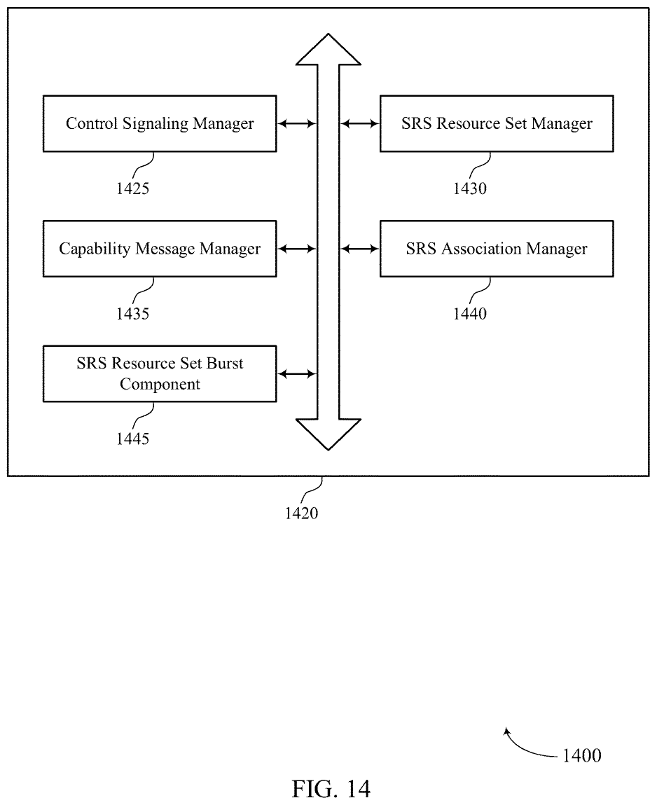

FIG. 14 shows a block diagram 1400 of a communications manager 1420 that supports techniques for SRS resource set repetition in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of techniques for SRS resource set repetition as described herein. For example, the communications manager 1420 may include a control signaling manager 1425, an SRS resource set manager 1430, a capability message manager 1435, an SRS association manager 1440, an SRS resource set burst component 1445, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communication at a network entity in accordance with examples as disclosed herein. The control signaling manager 1425 is capable of, configured to, or operable to support a means for transmitting a control signaling indicating a first time domain periodicity value for transmitting a first SRS resource set burst via a set of multiple SRS resource set occasions, where a first SRS resource set in a first SRS resource set occasion of the set of multiple SRS resource set occasions and a second SRS resource set in a second SRS resource set occasion of the set of multiple SRS resource set occasions are to be received in accordance with the first time domain periodicity value. The SRS resource set manager 1430 is capable of, configured to, or operable to support a means for receiving, in accordance with the first time domain periodicity value, a first SRS via the first SRS resource set and a first SRS via the second SRS resource set using a common transmit spatial filter based on the control signaling.

In some examples, to support transmitting the control signaling, the control signaling manager 1425 is capable of, configured to, or operable to support a means for transmitting an indication of a second time domain periodicity value for transmitting a set of multiple SRS resource set bursts including the first SRS resource set burst and a second SRS resource set burst, where the first SRS resource set burst and the second SRS resource set burst are to be transmitted in accordance with the second time domain periodicity value.

In some examples, the SRS resource set burst component 1445 is capable of, configured to, or operable to support a means for receiving, in accordance with the second time domain periodicity value, a first SRS via the first SRS resource set burst and a first SRS via the second SRS resource set burst using a common transmit spatial filter.

In some examples, the SRS resource set burst component 1445 is capable of, configured to, or operable to support a means for receiving, in accordance with the second time domain periodicity value, a first SRS via the first SRS resource set burst using a first transmit spatial filter and a first SRS via the second SRS resource set burst using a second transmit spatial filter that is different than the first transmit spatial filter.

In some examples, to support transmitting the control signaling, the control signaling manager 1425 is capable of, configured to, or operable to support a means for transmitting a radio resource control message including the control signaling, the radio resource control message indicating a time domain prediction usage of the set of multiple SRS resource set occasions.

Additionally, or alternatively, the communications manager 1420 may support wireless communications at a network entity in accordance with examples as disclosed herein. In some examples, the control signaling manager 1425 is capable of, configured to, or operable to support a means for transmitting control signaling indicating a set of multiple SRS resource sets including at least a first SRS resource set and a second SRS resource set, where each SRS resource set includes a same quantity of SRSs. In some examples, the SRS resource set manager 1430 is capable of, configured to, or operable to support a means for receiving a first SRS via the first SRS resource set and a second SRS via the second SRS resource set using a common transmit spatial filter based on the control signaling.

In some examples, the control signaling indicates whether the common transmit spatial filter is to be applied to a respective SRS in each of the set of multiple SRS resource sets.

In some examples, the capability message manager 1435 is capable of, configured to, or operable to support a means for receiving a capability message indicating a maximum number of SRS resource sets in the set of multiple SRS resource sets, a maximum number of SRSs for each SRS resource set of the set of multiple SRS resource sets, or both. In some examples, the first SRS in the second SRS set is associated with the first SRS in the first SRS set.

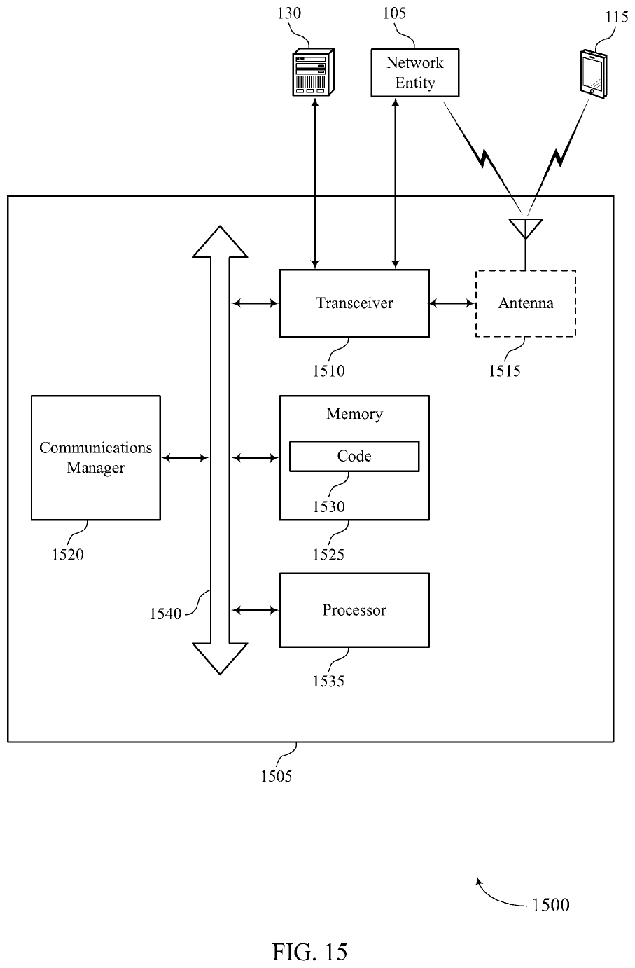

FIG. 15 shows a diagram of a system 1500 including a device 1505 that supports techniques for SRS resource set repetition in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or memory components (for example, the processor 1535, or the memory 1525, or both), may be included in a chip or chip assembly that is installed in the device 1505. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting techniques for SRS resource set repetition). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505. The processor 1535 may be any one or more suitable processors capable of executing scripts or instructions of one or more software programs stored in the device 1505 (such as within the memory 1525). In some implementations, the processor 1535 may be a component of a processing system. A processing system may generally refer to a system or series of machines or components that receives inputs and processes the inputs to produce a set of outputs (which may be passed to other systems or components of, for example, the device 1505). For example, a processing system of the device 1505 may refer to a system including the various other components or subcomponents of the device 1505, such as the processor 1535, or the transceiver 1510, or the communications manager 1520, or other components or combinations of components of the device 1505. The processing system of the device 1505 may interface with other components of the device 1505, and may process information received from other components (such as inputs or signals) or output information to other components. For example, a chip or modem of the device 1505 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1505 may transmit information output from the chip or modem. Additionally, or alternatively, in some implementations, the one or more interfaces may refer to an interface between the processing system of the chip or modem and a receiver, such that the device 1505 may obtain information or signal inputs, and the information may be passed to the processing system. A person having ordinary skill in the art will readily recognize that a first interface also may obtain information or signal inputs, and a second interface also may output information or signal outputs.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communication at a network entity in accordance with examples as disclosed herein. For example, the communications manager 1520 is capable of, configured to, or operable to support a means for transmitting a control signaling indicating a first time domain periodicity value for transmitting a first SRS resource set burst via a set of multiple SRS resource set occasions, where a first SRS resource set in a first SRS resource set occasion of the set of multiple SRS resource set occasions and a second SRS resource set in a second SRS resource set occasion of the set of multiple SRS resource set occasions are to be received in accordance with the first time domain periodicity value. The communications manager 1520 is capable of, configured to, or operable to support a means for receiving, in accordance with the first time domain periodicity value, a first SRS via the first SRS resource set and a first SRS via the second SRS resource set using a common transmit spatial filter based on the control signaling.

Additionally, or alternatively, the communications manager 1520 may support wireless communications at a network entity in accordance with examples as disclosed herein. For example, the communications manager 1520 is capable of, configured to, or operable to support a means for transmitting control signaling indicating a set of multiple SRS resource sets including at least a first SRS resource set and a second SRS resource set, where each SRS resource set includes a same quantity of SRSs. The communications manager 1520 is capable of, configured to, or operable to support a means for receiving a first SRS via the first SRS resource set and a second SRS via the second SRS resource set using a common transmit spatial filter based on the control signaling.

By including or configuring the communications manager 1520 in accordance with examples as described herein, the device 1505 may support techniques for transmitting SRS resource set repetitions for improved communication reliability, reduced latency, improved user experience related to reduced processing, reduced power consumption, more efficient utilization of communication resources, and improved coordination between devices.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, the processor 1535, the memory 1525, the code 1530, or any combination thereof. For example, the code 1530 may include instructions executable by the processor 1535 to cause the device 1505 to perform various aspects of techniques for SRS resource set repetition as described herein, or the processor 1535 and the memory 1525 may be otherwise configured to perform or support such operations.

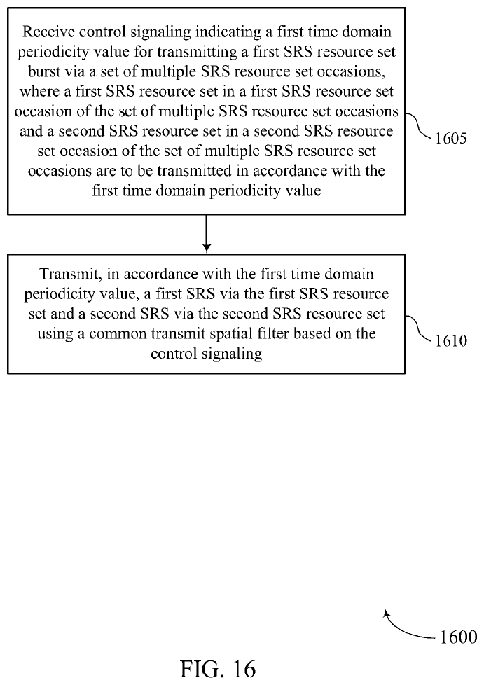

FIG. 16 shows a flowchart illustrating a method 1600 that supports techniques for SRS resource set repetition in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1605, the method may include receiving control signaling indicating a first time domain periodicity value for transmitting a first SRS resource set burst via a set of multiple SRS resource set occasions, where a first SRS resource set in a first SRS resource set occasion of the set of multiple SRS resource set occasions and a second SRS resource set in a second SRS resource set occasion of the set of multiple SRS resource set occasions are to be transmitted in accordance with the first time domain periodicity value. The operations of 1605 may be performed in accordance with examples as disclosed herein. In some examples, aspects of the operations of 1605 may be performed by a control signaling component 1025 as described with reference to FIG. 10.

At 1610, the method may include transmitting, in accordance with the first time domain periodicity value, a first SRS via the first SRS resource set and a second SRS via the second SRS resource set using a common transmit spatial filter based on the control signaling. The operations of 1610 may be performed in accordance with examples as disclosed herein. In some examples, aspects of the operations of 1610 may be performed by an SRS resource set component 1030 as described with reference to FIG. 10.

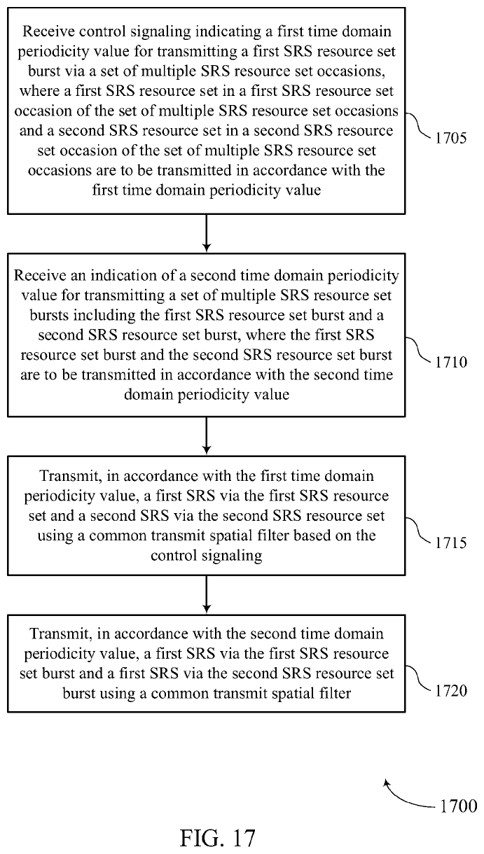

FIG. 17 shows a flowchart illustrating a method 1700 that supports techniques for SRS resource set repetition in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1705, the method may include receiving control signaling indicating a first time domain periodicity value for transmitting a first SRS resource set burst via a set of multiple SRS resource set occasions, where a first SRS resource set in a first SRS resource set occasion of the set of multiple SRS resource set occasions and a second SRS resource set in a second SRS resource set occasion of the set of multiple SRS resource set occasions are to be transmitted in accordance with the first time domain periodicity value. The operations of 1705 may be performed in accordance with examples as disclosed herein. In some examples, aspects of the operations of 1705 may be performed by a control signaling component 1025 as described with reference to FIG. 10.

At 1710, the method may include receiving an indication of a second time domain periodicity value for transmitting a set of multiple SRS resource set bursts including the first SRS resource set burst and a second SRS resource set burst, where the first SRS resource set burst and the second SRS resource set burst are to be transmitted in accordance with the second time domain periodicity value. The operations of 1710 may be performed in accordance with examples as disclosed herein. In some examples, aspects of the operations of 1710 may be performed by a control signaling component 1025 as described with reference to FIG. 10.

At 1715, the method may include transmitting, in accordance with the first time domain periodicity value, a first SRS via the first SRS resource set and a second SRS via the second SRS resource set using a common transmit spatial filter based on the control signaling. The operations of 1715 may be performed in accordance with examples as disclosed herein. In some examples, aspects of the operations of 1715 may be performed by an SRS resource set component 1030 as described with reference to FIG. 10.

At 1720, the method may include transmitting, in accordance with the second time domain periodicity value, a first SRS via the first SRS resource set burst and a first SRS via the second SRS resource set burst using a common transmit spatial filter. The operations of 1720 may be performed in accordance with examples as disclosed herein. In some examples, aspects of the operations of 1720 may be performed by an SRS resource set burst component 1045 as described with reference to FIG. 10.

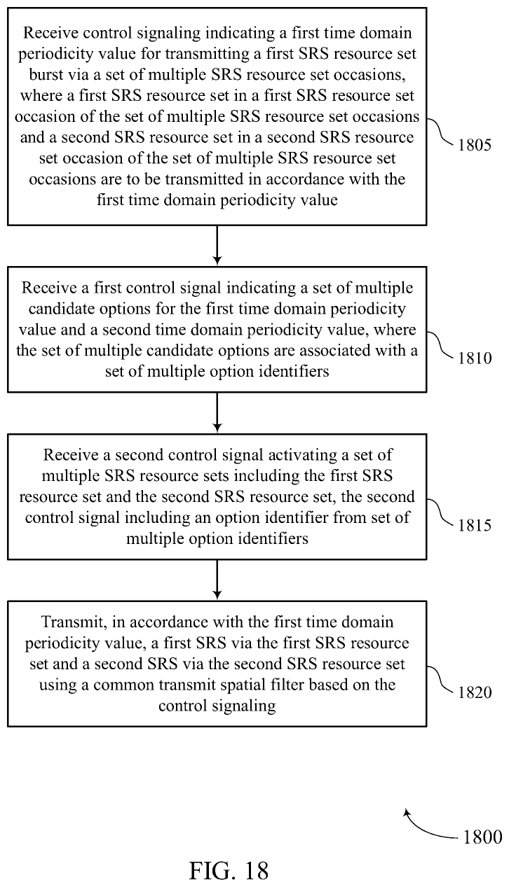

FIG. 18 shows a flowchart illustrating a method 1800 that supports techniques for SRS resource set repetition in accordance with aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1805, the method may include receiving control signaling indicating a first time domain periodicity value for transmitting a first SRS resource set burst via a set of multiple SRS resource set occasions, where a first SRS resource set in a first SRS resource set occasion of the set of multiple SRS resource set occasions and a second SRS resource set in a second SRS resource set occasion of the set of multiple SRS resource set occasions are to be transmitted in accordance with the first time domain periodicity value. The operations of 1805 may be performed in accordance with examples as disclosed herein. In some examples, aspects of the operations of 1805 may be performed by a control signaling component 1025 as described with reference to FIG. 10.

At 1810, the method may include receiving a first control signal indicating a set of multiple candidate options for the first time domain periodicity value and a second time domain periodicity value, where the set of multiple candidate options are associated with a set of multiple option IDs. The operations of 1810 may be performed in accordance with examples as disclosed herein. In some examples, aspects of the operations of 1810 may be performed by a control signaling component 1025 as described with reference to FIG. 10.

At 1815, the method may include receiving a second control signal activating a set of multiple SRS resource sets including the first SRS resource set and the second SRS resource set, the second control signal including an option ID from set of multiple option IDs. The operations of 1815 may be performed in accordance with examples as disclosed herein. In some examples, aspects of the operations of 1815 may be performed by a control signaling component 1025 as described with reference to FIG. 10.

At 1820, the method may include transmitting, in accordance with the first time domain periodicity value, a first SRS via the first SRS resource set and a second SRS via the second SRS resource set using a common transmit spatial filter based on the control signaling. The operations of 1820 may be performed in accordance with examples as disclosed herein. In some examples, aspects of the operations of 1820 may be performed by an SRS resource set component 1030 as described with reference to FIG. 10.

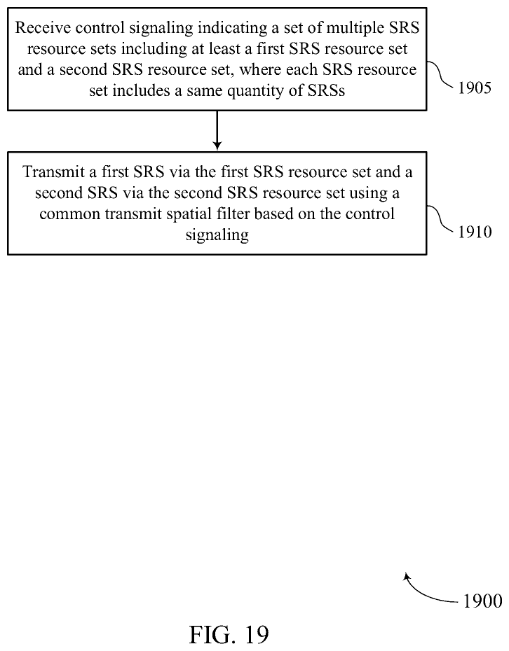

FIG. 19 shows a flowchart illustrating a method 1900 that supports techniques for SRS resource set repetition in accordance with aspects of the present disclosure. The operations of the method 1900 may be implemented by a UE or its components as described herein. For example, the operations of the method 1900 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1905, the method may include receiving control signaling indicating a set of multiple SRS resource sets including at least a first SRS resource set and a second SRS resource set, where each SRS resource set includes a same quantity of SRSs. The operations of 1905 may be performed in accordance with examples as disclosed herein. In some examples, aspects of the operations of 1905 may be performed by a control signaling component 1025 as described with reference to FIG. 10.

At 1910, the method may include transmitting a first SRS via the first SRS resource set and a second SRS via the second SRS resource set using a common transmit spatial filter based on the control signaling. The operations of 1910 may be performed in accordance with examples as disclosed herein. In some examples, aspects of the operations of 1910 may be performed by an SRS resource set component 1030 as described with reference to FIG. 10.

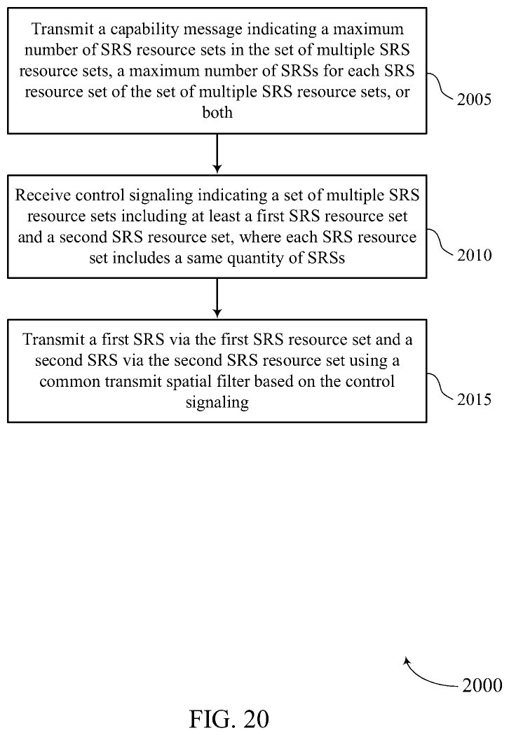

FIG. 20 shows a flowchart illustrating a method 2000 that supports techniques for SRS resource set repetition in accordance with aspects of the present disclosure. The operations of the method 2000 may be implemented by a UE or its components as described herein. For example, the operations of the method 2000 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 2005, the method may include transmitting a capability message indicating a maximum number of SRS resource sets in the set of multiple SRS resource sets, a maximum number of SRSs for each SRS resource set of the set of multiple SRS resource sets, or both. The operations of 2005 may be performed in accordance with examples as disclosed herein. In some examples, aspects of the operations of 2005 may be performed by a capability message component 1035 as described with reference to FIG. 10.

At 2010, the method may include receiving control signaling indicating a set of multiple SRS resource sets including at least a first SRS resource set and a second SRS resource set, where each SRS resource set includes a same quantity of SRSs. The operations of 2010 may be performed in accordance with examples as disclosed herein. In some examples, aspects of the operations of 2010 may be performed by a control signaling component 1025 as described with reference to FIG. 10.

At 2015, the method may include transmitting a first SRS via the first SRS resource set and a second SRS via the second SRS resource set using a common transmit spatial filter based on the control signaling. The operations of 2015 may be performed in accordance with examples as disclosed herein. In some examples, aspects of the operations of 2015 may be performed by an SRS resource set component 1030 as described with reference to FIG. 10.

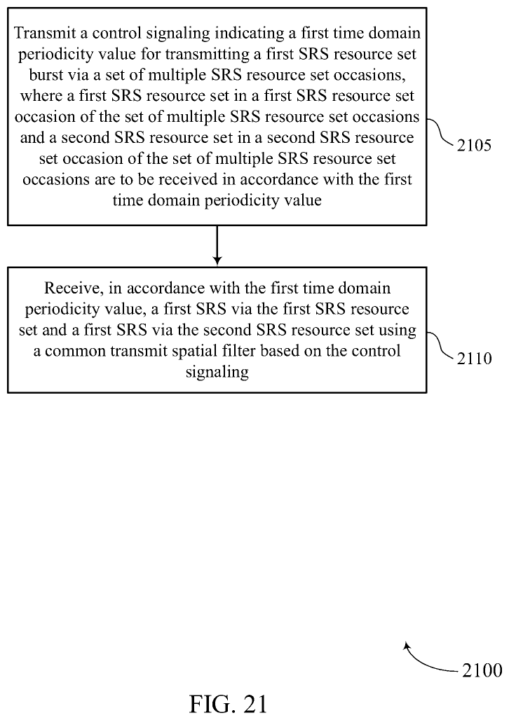

FIG. 21 shows a flowchart illustrating a method 2100 that supports techniques for SRS resource set repetition in accordance with aspects of the present disclosure. The operations of the method 2100 may be implemented by a network entity or its components as described herein. For example, the operations of the method 2100 may be performed by a network entity as described with reference to FIGS. 1 through 7 and 12 through 15. In some examples, a network entity may execute a set of instructions to control the functional elements of the wireless network entity to perform the described functions. Additionally, or alternatively, the wireless network entity may perform aspects of the described functions using special-purpose hardware.

At 2105, the method may include transmitting a control signaling indicating a first time domain periodicity value for transmitting a first SRS resource set burst via a set of multiple SRS resource set occasions, where a first SRS resource set in a first SRS resource set occasion of the set of multiple SRS resource set occasions and a second SRS resource set in a second SRS resource set occasion of the set of multiple SRS resource set occasions are to be received in accordance with the first time domain periodicity value. The operations of 2105 may be performed in accordance with examples as disclosed herein. In some examples, aspects of the operations of 2105 may be performed by a control signaling manager 1425 as described with reference to FIG. 14.

At 2110, the method may include receiving, in accordance with the first time domain periodicity value, a first SRS via the first SRS resource set and a first SRS via the second SRS resource set using a common transmit spatial filter based on the control signaling. The operations of 2110 may be performed in accordance with examples as disclosed herein. In some examples, aspects of the operations of 2110 may be performed by an SRS resource set manager 1430 as described with reference to FIG. 14.

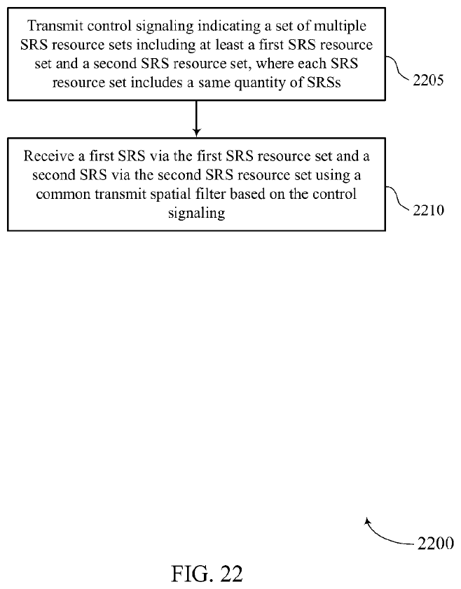

FIG. 22 shows a flowchart illustrating a method 2200 that supports techniques for SRS resource set repetition in accordance with aspects of the present disclosure. The operations of the method 2200 may be implemented by a network entity or its components as described herein. For example, the operations of the method 2200 may be performed by a network entity as described with reference to FIGS. 1 through 7 and 12 through 15. In some examples, a network entity may execute a set of instructions to control the functional elements of the wireless network entity to perform the described functions. Additionally, or alternatively, the wireless network entity may perform aspects of the described functions using special-purpose hardware.

At 2205, the method may include transmitting control signaling indicating a set of multiple SRS resource sets including at least a first SRS resource set and a second SRS resource set, where each SRS resource set includes a same quantity of SRSs. The operations of 2205 may be performed in accordance with examples as disclosed herein. In some examples, aspects of the operations of 2205 may be performed by a control signaling manager 1425 as described with reference to FIG. 14.

At 2210, the method may include receiving a first SRS via the first SRS resource set and a second SRS via the second SRS resource set using a common transmit spatial filter based on the control signaling. The operations of 2210 may be performed in accordance with examples as disclosed herein. In some examples, aspects of the operations of 2210 may be performed by an SRS resource set manager 1430 as described with reference to FIG. 14.

The following provides an overview of aspects of the present disclosure:

Aspect 1: A method for wireless communication at a UE, comprising: receiving control signaling indicating a first time domain periodicity value for transmitting a first SRS resource set burst via a plurality of SRS resource set occasions, wherein a first SRS resource set in a first SRS resource set occasion of the plurality of SRS resource set occasions and a second SRS resource set in a second SRS resource set occasion of the plurality of SRS resource set occasions are to be transmitted in accordance with the first time domain periodicity value; and transmitting, in accordance with the first time domain periodicity value, a first SRS via the first SRS resource set and a second SRS via the second SRS resource set using a common transmit spatial filter based at least in part on the control signaling.

Aspect 2: The method of aspect 1, wherein receiving the control signaling comprises: receiving an indication of a second time domain periodicity value for transmitting a plurality of SRS resource set bursts comprising the first SRS resource set burst and a second SRS resource set burst, wherein the first SRS resource set burst and the second SRS resource set burst are to be transmitted in accordance with the second time domain periodicity value.

Aspect 3: The method of aspect 2, further comprising: transmitting, in accordance with the second time domain periodicity value, a first SRS via the first SRS resource set burst and a first SRS via the second SRS resource set burst using a common transmit spatial filter.

Aspect 4: The method of aspect 2, further comprising: transmitting, in accordance with the second time domain periodicity value, a first SRS via the first SRS resource set burst using a first transmit spatial filter and a first SRS via the second SRS resource set burst using a second transmit spatial filter that is different than the first transmit spatial filter.

Aspect 5: The method of any of aspects 1 through 4, wherein receiving the control signaling further comprises: receiving a radio resource control message comprising the control signaling, the radio resource control message indicating a time domain prediction usage of the plurality of SRS resource set occasions.

Aspect 6: The method of aspect 5, wherein the radio resource control message comprises an indication of the common transmit spatial filter applied to a respective SRS in each of a plurality of SRS resource sets, a common transmit spatial filter applied to a respective SRS in each of a plurality of SRS resource set bursts, or both.

Aspect 7: The method of aspect 5, wherein the radio resource control message comprises a radio resource control flag indicating whether the common transmit spatial filter is to be applied to a respective SRS in each of a plurality of SRS resource sets, whether a common transmit spatial filter is to be applied to a respective SRS in each of a plurality of SRS resource set bursts, or both.

Aspect 8: The method of aspect 1, wherein receiving the control signaling further comprises: receiving a medium access control channel element message activating a plurality of SRS resource sets comprising the first SRS resource set and the second SRS resource set, wherein the medium access control channel element message indicates whether the common transmit spatial filter is to be applied to a respective SRS in each of the plurality of SRS resource sets, whether a common transmit spatial filter is to be applied to a respective SRS in each of a plurality of SRS resource set bursts, or both.

Aspect 9: The method of aspect 1, wherein receiving the control signaling further comprises: receiving a first medium access control channel element message activating a plurality of SRS resource sets comprising the first SRS resource set and the second SRS resource set; and receiving a second medium access control channel element message indicating one or more SRS resource set identifiers, wherein the second medium access control channel element message indicates whether the common transmit spatial filter is to be applied to a respective SRS in each of the plurality of SRS resource sets, whether a common transmit spatial filter is to be applied to a respective SRS in each of a plurality of SRS resource set bursts, or both.

Aspect 10: The method of aspect 1, wherein receiving the control signaling further comprises: receiving a downlink control information message comprising the control signaling, the downlink control information message indicating whether the common transmit spatial filter is to be applied to a respective SRS in each of a plurality of SRS resource sets, whether a common transmit spatial filter is to be applied to a respective SRS in each of a plurality of SRS resource set bursts, or both.

Aspect 11: The method of aspect 10, wherein the downlink control information message comprises a SRS resource set identifier and indicates whether the common transmit spatial filter is to be applied to a respective SRS in each of the plurality of SRS resource sets, whether a common transmit spatial filter is to be applied to a respective SRS in each of the plurality of SRS resource set bursts, or both, based at least in part on the SRS resource set identifier.

Aspect 12: The method of aspect 1, wherein receiving the control signaling further comprises: receiving a first control signal indicating a plurality of candidate options for the first time domain periodicity value and a second time domain periodicity value, wherein the plurality of candidate options are associated with a plurality of option identifiers; and receiving a second control signal activating a plurality of SRS resource sets comprising the first SRS resource set and the second SRS resource set, the second control signal comprising an option identifier from plurality of option identifiers.

Aspect 13: A method for wireless communication at a UE, comprising: receiving control signaling indicating a plurality of SRS resource sets including at least a first SRS resource set and a second SRS resource set, wherein each SRS resource set comprises a same quantity of SRSs; and transmitting a first SRS via the first SRS resource set and a second SRS via the second SRS resource set using a common transmit spatial filter based at least in part on the control signaling.

Aspect 14: The method of aspect 13, wherein the control signaling indicates whether the common transmit spatial filter is to be applied to a respective SRS in each of the plurality of SRS resource sets.

Aspect 15: The method of any of aspects 13 through 14, wherein receiving the control signaling further comprises: receiving a radio resource control message comprising the control signaling, the radio resource control message indicating a time domain prediction usage of a plurality of SRS resource set occasions.

Aspect 16: The method of aspect 15, wherein the usage of the radio resource control message is a sub usage of a beam management usage.

Aspect 17: The method of any of aspects 15 through 16, wherein each SRS resource set with the usage of time domain predication is associated with each other in accordance with a single virtual SRS resource set, and wherein a quantity of SRSs within the single virtual SRS resource set is based at least in part on a quantity of SRSs within each associated SRS resource set.

Aspect 18: The method of any of aspects 13 through 17, further comprising:

transmitting a capability message indicating a maximum number of SRS resource sets in the plurality of SRS resource sets, a maximum number of SRSs for each SRS resource set of the plurality of SRS resource sets, or both.

Aspect 19: The method of any of aspects 13 through 18, wherein the first SRS in the second SRS set is associated with the first SRS in the first SRS set.

Aspect 20: The method of any of aspects 13 through 19, wherein each SRS resource set of the plurality of SRS resource sets comprises a SRS resource set identifier indicating that the SRS resource set is associated with the first SRS resource set.

Aspect 21: The method of any of aspects 13 through 20, wherein each SRS resource set of the plurality of SRS resource sets comprises a group identifier indicating that the SRS resource set is associated with a group of SRS resource sets.

Aspect 22: A method for wireless communication at a network entity, comprising: transmitting a control signaling indicating a first time domain periodicity value for transmitting a first SRS resource set burst via a plurality of SRS resource set occasions, wherein a first SRS resource set in a first SRS resource set occasion of the plurality of SRS resource set occasions and a second SRS resource set in a second SRS resource set occasion of the plurality of SRS resource set occasions are to be received in accordance with the first time domain periodicity value; and receiving, in accordance with the first time domain periodicity value, a first SRS via the first SRS resource set and a first SRS via the second SRS resource set using a common transmit spatial filter based at least in part on the control signaling.

Aspect 23: The method of aspect 22, wherein transmitting the control signaling comprises: transmitting an indication of a second time domain periodicity value for transmitting a plurality of SRS resource set bursts comprising the first SRS resource set burst and a second SRS resource set burst, wherein the first SRS resource set burst and the second SRS resource set burst are to be transmitted in accordance with the second time domain periodicity value.

Aspect 24: The method of aspect 23, further comprising: receiving, in accordance with the second time domain periodicity value, a first SRS via the first SRS resource set burst and a first SRS via the second SRS resource set burst using a common transmit spatial filter.

Aspect 25: The method of aspect 23, further comprising: receiving, in accordance with the second time domain periodicity value, a first SRS via the first SRS resource set burst using a first transmit spatial filter and a first SRS via the second SRS resource set burst using a second transmit spatial filter that is different than the first transmit spatial filter.

Aspect 26: The method of any of aspects 22 through 25, wherein transmitting the control signaling further comprises: transmitting a radio resource control message comprising the control signaling, the radio resource control message indicating a time domain prediction usage of the plurality of SRS resource set occasions.

Aspect 27: A method for wireless communications at a network entity, comprising: transmitting control signaling indicating a plurality of SRS resource sets including at least a first SRS resource set and a second SRS resource set, wherein each SRS resource set comprises a same quantity of SRSs; and receiving a first SRS via the first SRS resource set and a second SRS via the second SRS resource set using a common transmit spatial filter based at least in part on the control signaling.

Aspect 28: The method of aspect 27, wherein the control signaling indicates whether the common transmit spatial filter is to be applied to a respective SRS in each of the plurality of SRS resource sets.

Aspect 29: The method of any of aspects 27 through 28, further comprising: receiving a capability message indicating a maximum number of SRS resource sets in the plurality of SRS resource sets, a maximum number of SRSs for each SRS resource set of the plurality of SRS resource sets, or both.

Aspect 30: The method of any of aspects 27 through 29, wherein the first SRS in the second SRS set is associated with the first SRS in the first SRS set.

Aspect 31: An apparatus for wireless communication at a UE, comprising a processor; memory coupled with the processor; and instructions stored in the memory and executable by the processor to cause the apparatus to perform a method of any of aspects 1 through 12.

Aspect 32: An apparatus for wireless communication at a UE, comprising at least one means for performing a method of any of aspects 1 through 12.

Aspect 33: A non-transitory computer-readable medium storing code for wireless communication at a UE, the code comprising instructions executable by a processor to perform a method of any of aspects 1 through 12.

Aspect 34: An apparatus for wireless communication at a UE, comprising a processor; memory coupled with the processor; and instructions stored in the memory and executable by the processor to cause the apparatus to perform a method of any of aspects 13 through 21.

Aspect 35: An apparatus for wireless communication at a UE, comprising at least one means for performing a method of any of aspects 13 through 21.

Aspect 36: A non-transitory computer-readable medium storing code for wireless communication at a UE, the code comprising instructions executable by a processor to perform a method of any of aspects 13 through 21.

Aspect 37: An apparatus for wireless communication at a network entity, comprising a processor; memory coupled with the processor; and instructions stored in the memory and executable by the processor to cause the apparatus to perform a method of any of aspects 22 through 26.

Aspect 38: An apparatus for wireless communication at a network entity, comprising at least one means for performing a method of any of aspects 22 through 26.

Aspect 39: A non-transitory computer-readable medium storing code for wireless communication at a network entity, the code comprising instructions executable by a processor to perform a method of any of aspects 22 through 26.

Aspect 40: An apparatus for wireless communications at a network entity, comprising a processor; memory coupled with the processor; and instructions stored in the memory and executable by the processor to cause the apparatus to perform a method of any of aspects 27 through 30.

Aspect 41: An apparatus for wireless communications at a network entity, comprising at least one means for performing a method of any of aspects 27 through 30.

Aspect 42: A non-transitory computer-readable medium storing code for wireless communications at a network entity, the code comprising instructions executable by a processor to perform a method of any of aspects 27 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Also, as used herein, the phrase “a set” shall be construed as including the possibility of a set with one member. That is, the phrase “a set” shall be construed in the same manner as “one or more.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
a processor;
memory coupled with the processor; and
instructions stored in the memory and executable by the processor to cause the apparatus to:
receive control signaling indicating a first time domain periodicity value for transmitting a first sounding reference signal (SRS) resource set burst via a plurality of SRS resource set occasions, wherein a first SRS resource set in a first SRS resource set occasion of the plurality of SRS resource set occasions and a second SRS resource set in a second SRS resource set occasion of the plurality of SRS resource set occasions are to be transmitted in accordance with the first time domain periodicity value; and
transmit, in accordance with the first time domain periodicity value, a first SRS via the first SRS resource set and a second SRS via the second SRS resource set using a common transmit spatial filter based at least in part on the control signaling.

2. The apparatus of claim 1, wherein the instructions to receive the control signaling are executable by the processor to cause the apparatus to:
receive an indication of a second time domain periodicity value for transmitting a plurality of SRS resource set bursts comprising the first SRS resource set burst and a second SRS resource set burst, wherein the first SRS resource set burst and the second SRS resource set burst are to be transmitted in accordance with the second time domain periodicity value.

3. The apparatus of claim 2, wherein the instructions are further executable by the processor to cause the apparatus to:
transmit, in accordance with the second time domain periodicity value, a first SRS via the first SRS resource set burst and a first SRS via the second SRS resource set burst using a common transmit spatial filter.

4. The apparatus of claim 2, wherein the instructions are further executable by the processor to cause the apparatus to:
transmit, in accordance with the second time domain periodicity value, a first SRS via the first SRS resource set burst using a first transmit spatial filter and a first SRS via the second SRS resource set burst using a second transmit spatial filter that is different than the first transmit spatial filter.

5. The apparatus of claim 1, wherein the instructions to receive the control signaling are further executable by the processor to cause the apparatus to:
receive a radio resource control message comprising the control signaling, the radio resource control message indicating a time domain prediction usage of the plurality of SRS resource set occasions.

6. The apparatus of claim 5, wherein the radio resource control message comprises an indication of the common transmit spatial filter applied to a respective SRS in each of a plurality of SRS resource sets, a common transmit spatial filter applied to a respective SRS in each of a plurality of SRS resource set bursts, or both.

7. The apparatus of claim 5, wherein the radio resource control message comprises a radio resource control flag indicating whether the common transmit spatial filter is to be applied to a respective SRS in each of a plurality of SRS resource sets, whether a common transmit spatial filter is to be applied to a respective SRS in each of a plurality of SRS resource set bursts, or both.

8. The apparatus of claim 1, wherein the instructions to receive the control signaling are further executable by the processor to cause the apparatus to:
receive a medium access control channel element message activating a plurality of SRS resource sets comprising the first SRS resource set and the second SRS resource set, wherein the medium access control channel element message indicates whether the common transmit spatial filter is to be applied to a respective SRS in each of the plurality of SRS resource sets, whether a common transmit spatial filter is to be applied to a respective SRS in each of a plurality of SRS resource set bursts, or both.

9. The apparatus of claim 1, wherein the instructions to receive the control signaling are further executable by the processor to cause the apparatus to:
receive a first medium access control channel element message activating a plurality of SRS resource sets comprising the first SRS resource set and the second SRS resource set; and
receive a second medium access control channel element message indicating one or more SRS resource set identifiers, wherein the second medium access control channel element message indicates whether the common transmit spatial filter is to be applied to a respective SRS in each of the plurality of SRS resource sets, whether a common transmit spatial filter is to be applied to a respective SRS in each of a plurality of SRS resource set bursts, or both.

10. The apparatus of claim 1, wherein the instructions to receive the control signaling are further executable by the processor to cause the apparatus to:
receive a downlink control information message comprising the control signaling, the downlink control information message indicating whether the common transmit spatial filter is to be applied to a respective SRS in each of a plurality of SRS resource sets, whether a common transmit spatial filter is to be applied to a respective SRS in each of a plurality of SRS resource set bursts, or both.

11. The apparatus of claim 10, wherein the downlink control information message comprises a SRS resource set identifier and indicates whether the common transmit spatial filter is to be applied to a respective SRS in each of the plurality of SRS resource sets, whether a common transmit spatial filter is to be applied to a respective SRS in each of the plurality of SRS resource set bursts, or both, based at least in part on the SRS resource set identifier.

12. The apparatus of claim 1, wherein the instructions to receive the control signaling are further executable by the processor to cause the apparatus to:
receive a first control signal indicating a plurality of candidate options for the first time domain periodicity value and a second time domain periodicity value, wherein the plurality of candidate options are associated with a plurality of option identifiers; and
receive a second control signal activating a plurality of SRS resource sets comprising the first SRS resource set and the second SRS resource set, the second control signal comprising an option identifier from plurality of option identifiers.

13. An apparatus for wireless communication at a user equipment (UE), comprising:
a processor;
memory coupled with the processor; and
instructions stored in the memory and executable by the processor to cause the apparatus to:
receive control signaling indicating a plurality of sounding reference signal (SRS) resource sets including at least a first SRS resource set and a second SRS resource set, wherein each SRS resource set comprises a same quantity of SRSs; and
transmit a first SRS via the first SRS resource set and a second SRS via the second SRS resource set using a common transmit spatial filter based at least in part on the control signaling.

14. The apparatus of claim 13, wherein the control signaling indicates whether the common transmit spatial filter is to be applied to a respective SRS in each of the plurality of SRS resource sets.

15. The apparatus of claim 13, wherein the instructions to receive the control signaling are further executable by the processor to cause the apparatus to:
receive a radio resource control message comprising the control signaling, the radio resource control message indicating a time domain prediction usage of a plurality of SRS resource sets.

16. The apparatus of claim 15, wherein the usage of the radio resource control message is a sub usage of a beam management usage.

17. The apparatus of claim 15, wherein each SRS resource set with the usage of time domain predication is associated with each other in accordance with a single virtual SRS resource set, and wherein a quantity of SRSs within the single virtual SRS resource set is based at least in part on a quantity of SRSs within each associated SRS resource set.

18. The apparatus of claim 13, wherein the instructions are further executable by the processor to cause the apparatus to:
transmit a capability message indicating a maximum number of SRS resource sets in the plurality of SRS resource sets, a maximum number of SRSs for each SRS resource set of the plurality of SRS resource sets, or both.

19. The apparatus of claim 13, wherein the first SRS in the second SRS set is associated with the first SRS in the first SRS set.

20-21. (canceled)

22. An apparatus for wireless communication at a network entity, comprising:
a processor;
memory coupled with the processor; and
instructions stored in the memory and executable by the processor to cause the apparatus to:
transmit a control signaling indicating a first time domain periodicity value for transmitting a first sounding reference signal (SRS) resource set burst via a plurality of SRS resource set occasions, wherein a first SRS resource set in a first SRS resource set occasion of the plurality of SRS resource set occasions and a second SRS resource set in a second SRS resource set occasion of the plurality of SRS resource set occasions are to be received in accordance with the first time domain periodicity value; and
receive, in accordance with the first time domain periodicity value, a first SRS via the first SRS resource set and a first SRS via the second SRS resource set using a common transmit spatial filter based at least in part on the control signaling.

23-30. (canceled)
